(19) United States
(12) Patent Application Publication
(10) Pub. No.: US 2026/0179124 A1
(43) Pub. Date: Jun. 25, 2026

(54) USER TRAIT BASED RESOURCE ALLOCATION OF ADVERTISEMENT SYSTEMS, EFFICIENT DEPTH STABILIZER FOR AUGMENTED REALITY - MIXED REALITY & TIME BASED INSERTION OF ADVERTISEMENTS

(71) Applicant: Meta Platforms, Inc., Menlo Park, CA (US)

(72) Inventors: Praveen Alevoor, Sunnyvale, CA (US); Shivam Agarwal, Fremont, CA (US); Ha Trong Hong Nguyen, San Carlos, CA (US); Mengchu Cheng, Palo Alto, CA (US); Julaiti Alafate, San Francisco, CA (US); Lukasz Jan Szczyglowski, Redwood City, CA (US); Khalil Javed, Frisco, TX (US); Rakesh Ranjan, Mountain View, CA (US); Hao Jiang, Bellevue, WA (US); Sudharsan Vasudevan, Dublin, CA (US)

(21) Appl. No.: 19/427,340

(22) Filed: Dec. 19, 2025

Related U.S. Application Data
(60) Provisional application No. 63/738,473, filed on Dec. 23, 2024.
(60) Provisional application No. 63/738,231, filed on Dec. 23, 2024.
(60) Provisional application No. 63/738,724, filed on Dec. 24, 2024.

(51) Int. Cl. G06Q 30/0251; G06Q 10/40; G06T 7/50

(52) U.S. Cl. CPC G06Q 30/0269; G06Q 10/40; G06T 7/50; G06T 2207/20084

(57) ABSTRACT

The present disclosure provides systems and methods for allocating processing resources based on an online presence score. In various examples, systems and methods may receive user interaction data associated with a platform for a predetermined period of time. In response to receiving user interaction data, an online presence score associated with a user may be determined. A plurality of advertisements may be ranked, where allocation of processing resources may be based on the online presence score in relation to a plurality of intervals. Online presence scores associated with a first interval may trigger more processing resources to be allocated for ranking advertisements. Conversely, online presence scores associated with a second interval may trigger less processing resources to be allocated for ranking advertisements.

### CROSS-REFERENCE TO RELATED APPLICATIONS

This application claims priority to U.S. Provisional Application No. 63/738,473, filed Dec. 23, 2024, entitled “User Trait Based Resource Allocation Of Advertisement Systems,” and U.S. Provisional Application No. 63/738,231, filed Dec. 23, 2024, entitled “Efficient Depth Stability For Augmented Reality-Mixed Reality,” and U.S. Provisional Application No. 63/738,724, filed Dec. 24, 2024, entitled “Time Based Insertion Of Advertisements,” which are incorporated by reference herein in their entireties.

### TECHNOLOGICAL FIELD

The present disclosure generally relates to systems and methods for allocating resources associated with advertisement systems.

### BACKGROUND

An online presence may include user interactions with content on a platform. Such content may include products and items associated with a brand, an activity of interest, or the like. As such, many platforms in association with advertisers (e.g., entities) may utilize online presence to determine which content to provide to users based on an association between online presence and a likelihood of user interaction. As more users interact with content on a platform, advertisers are increasingly soliciting platforms with a large number of users to promote their products or content. However, with the increased number of advertisers more content (e.g., ads) may be available to the platform. As such, current advertising technology platforms may face significant challenges providing a content item that may result in user interaction.

### BRIEF SUMMARY

Various systems, methods, and devices are described for ranking advertisements based on an online presence score. In some examples, based on the online presence determined resources may be allocated to provide more efficient ranking of advertisements. Advertisements may include but not limited to, product ads, content ads, or the like, or other promotion to a user, an online profile, or any other suitable type of online presence.

In various examples, systems and methods may receive user interaction data associated with a platform for a predetermined period of time. An online presence score may be determined based on the user interaction data received. Based on the online presence score determined, a plurality of advertisements may be ranked. The processing resources associated with ranking the plurality of advertisements may be allocated based on the online presence score determined. In an example, processing resources allocated for ranking the plurality of advertisements may be determined based on the online presence score(s). The processing resources allocated may be further determined based on the online presence score(s) in relation to a plurality of intervals.

In an example, when the online presence score is associated with a first interval of the plurality of intervals, more processing resources (e.g., a majority of the maximum processing resources) may be allocated to performing ranking of at least a portion of the plurality of advertisements. The first interval of the plurality of intervals may be associated with a high online presence score. The online presence score(s) associated with the first interval may be indicative of a target user.

In an example, when the online presence score(s) is associated with a second interval of the plurality of intervals, less processing resources (e.g., a remaining available resources) may be allocated to perform ranking of at least another portion of the plurality of advertisements. The second interval of the plurality of intervals may be associated with a low online presence score. The online presence score(s) associated with the second interval may be indicative of a nontarget user.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates an example system in accordance with an example of the present disclosure.

FIG. 2 illustrates an example method in accordance with an example of the present disclosure.

FIG. 3 illustrates an example computing device in accordance with an example of the present disclosure.

FIG. 4 illustrates a diagram of an exemplary computing system in accordance with an example of the present disclosure.

FIG. 5 illustrates a machine learning and training model in accordance with an example of the present disclosure.

FIG. 6 illustrates a diagram of an exemplary network environment in accordance with one or more example aspects of the subject technology.

FIG. 7 illustrates a diagram of an exemplary communication device in accordance with one or more example aspects of the subject technology.

FIG. 8 illustrates an exemplary computing system in accordance with one or more example aspects of the subject technology.

FIG. 9 illustrates a machine learning and training model framework in accordance with example aspects of the present disclosure.

FIG. 10 illustrates a model for depth estimation in accordance with example aspects of the present disclosure.

FIG. 11 illustrates a network for depth estimation in accordance with example aspects of the present disclosure.

FIG. 12 illustrates a depth estimation and dynamic object mask maps in accordance with example aspects of the present disclosure.

FIG. 13 illustrates a depth estimation and dynamic object mask maps in accordance with example aspects of the present disclosure.

FIG. 14 illustrates a depth estimation map in accordance with example aspects of the present disclosure.

FIG. 15 illustrates a depth estimation map in accordance with example aspects of the present disclosure.

FIG. 16 illustrates depth estimation maps in accordance with example aspects of the present disclosure.

FIG. 17 illustrates depth estimation maps in accordance with example aspects of the present disclosure.

FIG. 18 illustrates depth estimation maps in accordance with example aspects of the present disclosure.

FIG. 19 illustrates depth estimation maps in accordance with example aspects of the present disclosure.

FIG. 20 illustrates depth estimation maps in accordance with example aspects of the present disclosure.

FIG. 21 illustrates depth estimation maps in accordance with example aspects of the present disclosure.

FIG. 22 illustrates a dynamic mask estimation process in accordance with example aspects of the present disclosure.

FIG. 23 illustrates a depth estimation and occlusion mask maps in accordance with example aspects of the present disclosure.

FIG. 24 illustrates fusion mask maps in accordance with example aspects of the present disclosure.

FIG. 25 illustrates AR/MR images, in accordance with example aspects of the present disclosure.

FIG. 26 illustrates AR/MR images, in accordance with example aspects of the present disclosure.

FIG. 27 illustrates a process for model training for depth estimation in accordance with example aspects of the present disclosure.

FIG. 28 illustrates a diagram for motion compensation for depth estimation in accordance with example aspects of the present disclosure.

FIG. 29A illustrates an exemplary system for selective delivery of advertisements.

FIG. 29B is an example method for how the social media platform may display an article of content.

FIG. 29C illustrates an exemplary system for selection of how an advertisement may be inserted into a content feed associated with a user profile on a social media platform.

FIG. 30A is an example method for processing and delivering advertisements.

FIG. 30B is an example method for how the server may determine which method of advertisement insertion aligns with engagement with the social media platform.

FIG. 31 illustrates an example block diagram of an exemplary computing device suitable for implementing aspects of the disclosed subject matter.

The figures depict various examples for purposes of illustration only. One skilled in the art will readily recognize from the following discussion that alternative examples of the structures and methods illustrated herein may be employed without departing from the principles described herein.

### A. User Trait Based Resource Allocation of Advertisement Systems

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a “product” may refer to any product, content, information, or the like that an individual or entity may want to share with others via a content item(s) such as, for example, an advertisement. One example of a product may be a content creator sharing their user profile via an advertisement(s) to increase viewership of their content (e.g., videos, posts, photos, stories, reels, or any combination thereof.

References in this description to “an example”, “one example”, or the like, may mean that the particular feature, function, or characteristic being described is included in at least one example of the present invention. Occurrences of such phrases in this specification do not necessarily all refer to the same example, nor are they necessarily mutually exclusive.

It is to be understood that the methods and systems described herein are not limited to specific methods, specific components, or to particular implementations. It is also to be understood that the terminology used herein is for the purpose of describing particular examples only and is not intended to be limiting.

As participation in online platforms, such as social media platforms, increases some advertisers (e.g., customers) may want to advertise their content to users, who interact with online platforms. However, with current advertising technology advertising to users may not consider a user's value or the potential at which a user may interact with platforms or advertisements to purchase items or products. Conventional methods rank advertisements without taking into account a user's interactions with a platform (e.g., social media platform, messaging platform, or the like). Disclosed herein are methods, systems, or apparatuses that may capture various user interaction signals to categorize users by various interaction criterions. The interaction criterions may be utilized to provide a potential monetary value associated with the user. As a result, the number of ads ranked for the categories defined herein may be optimized. As such, resources may be allocated more efficiently, which may lead to increased revenue for advertisers and entities associated with platforms. The present disclosure may be utilized to allocate more processing power or resources to users that may have the highest potential monetary value. As such, the disclosed may provide an improved user experience for users that may interact with the platform the most. Resulting in an a more effective advertisement ranking system that may increase revenue for advertisers.

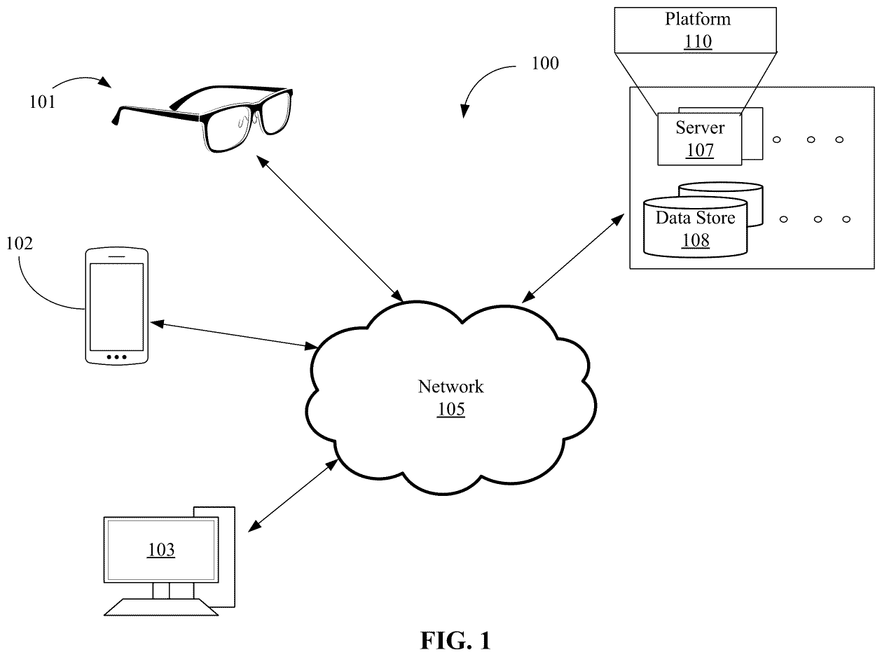

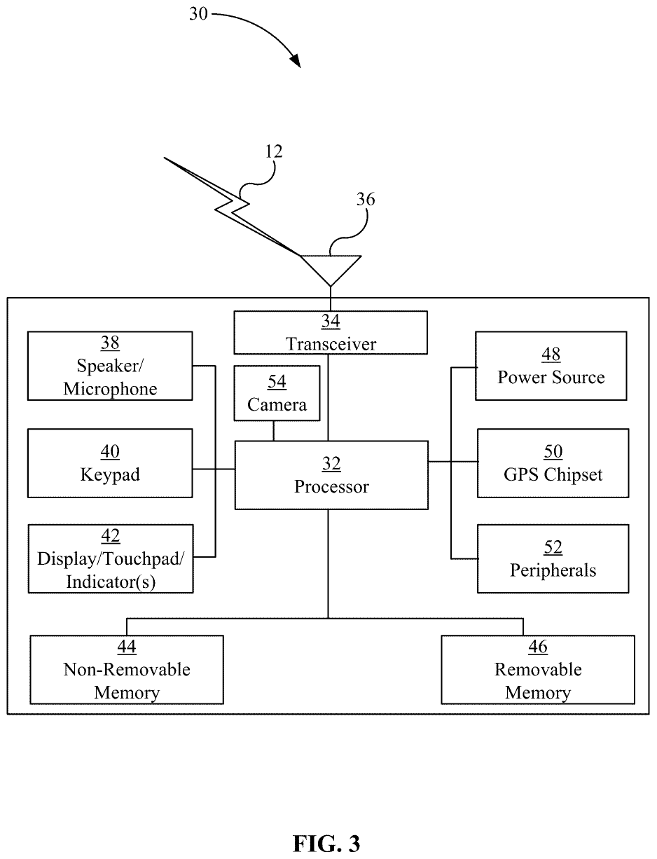

FIG. 1 illustrates an example system 100 according to example aspects of the present disclosure. The system 100 may be capable of facilitating communication among entities or provisioning content among entities. The system 100 may include one or more communication devices 101, 102, 103 (also may be referred to herein as user devices 101, 102, 103), server 107, data store 108, or platform 110. In an example, communication devices 101, 102, and 103 may be examples of user equipment (UE) (e.g., UE 30 of FIG. 3). As shown for simplicity, platform 110 may be located on server 107 or interact with one or more devices of system 100. It is contemplated that platform 110 may be located on or interact (e.g., communicate) with one or more devices (e.g., communication devices 101, 102, 103) of system 100.

In particular examples, device 101 may be associated with an individual (e.g., a user), platform 110 may be associated with an application(s), the devices of system 100 (e.g., devices 102, 102, 103) may comprise a group that may be associated with a community (e.g., group of individuals or entities) that interacts or communicates with platform 110. In some examples, platform 110 may be considered, or associated with, an application (e.g., a media platform, a function of a social media platform, a message platform, or the like). In particular examples, one or more users may use one or more devices (e.g., devices 101, 102, 103) to access, send data to, or receive data from platform 110 which may be located on a server 107, a device (e.g., device 101, 102, 103), or the like.

This disclosure contemplates any suitable network 105. As an example and not by way of limitation, one or more portions of network 105 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 105 may include one or more networks 105.

In particular examples, devices 101, 102, 103 may be an electronic device including hardware, software, or embedded logic components or a combination of two or more such components and capable of carrying out the appropriate functionalities implemented or supported by the communication devices 101, 102, 103. As an example and not by way of limitation, devices 101, 102, 103 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device(s) (e.g., communication devices 101, 102, 103). One or more of the communication devices 101, 102, 103 may be configured to access network 105. One or more of the communication devices 101, 102, 103 may enable a user(s) to communicate with other users at other devices 101, 102, 103 via network 105.

In particular examples, platform 110 may be a network-addressable computing system that may host an online advertising network, an online social media platform, marketplace, shop, and/or the like. Platform 110 may generate, store, or receive user information (also referred herein as user data) associated with a user, such as, for example, user-profile data, geographical location, or other suitable data related to the platform 110. Platform 110 may be accessed by one or more components of system 100 directly and/or via network 105. As an example and not by way of limitation, device 101 may access platform 110 located on server 107 by using a web browser or a native application on device 101 associated with platform 110 (e.g., a mobile interactive advertising application, a messaging application, social media application, another suitable application, or any combination thereof) directly or via network 105.

In particular examples, platform 110 may store one or more user profiles associated with user data in one or more data stores 108. In particular examples, an user profile may include multiple nodes—which may include multiple user nodes (each corresponding to a particular user associated with a device 101) or multiple concept nodes (each corresponding to a particular role or concept)—and multiple edges connecting the nodes. Users of the platform 110 may have the ability to communicate and interact with other users. In particular examples, users may join the platform 110 and then add connections (e.g., relationships) to a number of other users which may constitute a group of platform 110 to whom they want to be connected. User connections or communications may be monitored via platform 110 or any other suitable component of system 100. In an example, server 107 of platform 110 may receive, record, or otherwise obtain information associated with communications or connections of users (e.g., device 101, device 102, or device 103). As such, the monitored connections or communications may be utilized for determining trends related to a user's interest associated with a content item, product, item, or the like.

In particular examples, platform 110 may provide users with the ability to take actions on various types of content items. As an example and not by way of limitation, the items may include posts, videos, images, online marketplaces, texts, advertisements, or any other suitable items. A user may interact with any content item(s) that may be capable of being represented in platform 110. As such, user interactions with or in platform 110 may be recorded via platform 110.

In particular examples, platform 110 may track (e.g., monitor) user interactions (e.g., user interaction information) with the platform 110 associated with a plurality of content items (e.g., image(s), post(s), video(s), website(s), online shop(s), reel(s), one or more stories, content (e.g., advertisements), or the like, or any combination thereof presented to a user to determine an online presence score. User interactions may include a number of clicks associated with the plurality of content items, the duration at which the user may observe one or more content items of the plurality of content items, or the like, or any combination thereof. User interactions may be monitored or tracked over a predetermined period of time, which may be determined by any suitable device of the system 100. The predetermined period of time may be any suitable time period, such as but not limited to seconds, hours, minutes, days, months, years, or any suitable time period.

In an example, the online presence score may be a mathematical determination based on user interactions with the platform 110. The online presence score may be utilized to or include a potential monetary value associated with a user of the plurality of users. Users with a high online presence score may indicate a high potential monetary value, meaning that the user may interact with content items associated with platform 110 at a high rate which may lead to increased sales. Conversely, users with a low online presence score may indicate a low potential monetary value, meaning that the user may interact with content items associated with the platform 110 at a low rate which may not lead to increased sales. The user interaction information or online presence score may be stored via a database (e.g., data store 108) or server (e.g., server 107). In some examples, the user interaction information or online presence score may be stored temporarily or permanently based on the system 100.

In particular examples, system 100 may include one or more servers 107. Each of the servers 107 may be a unitary server or a distributed server spanning multiple computers or multiple datacenters. Servers 107 may be of various types, such as, for example and without limitation, web server, news server, mail server, message server, advertising server, file server, application server, exchange server, database server, proxy server, another server suitable for performing functions or processes described herein, or any combination thereof. In particular examples, each of the servers 107 may include hardware, software, or embedded logic components or a combination of two or more such components for carrying out the appropriate functionalities implemented or supported by server 107.

In particular examples, system 100 may include one or more data stores 108. Data stores 108 may be used to store various types of information. In particular examples, the information stored in data stores 108 may be organized according to specific data structures. In particular examples, each of the data stores 108 may be a relational, columnar, correlation, or other suitable database. Although this disclosure describes or illustrates particular types of databases, this disclosure contemplates any suitable types of databases. Particular examples may provide interfaces that enable communication devices 101, 102, 103 or another system (e.g., a third-party system) to manage, retrieve, modify, add, or delete, the information stored in data store 108. In some examples, the communication devices 101, 102, 103 may comprise a data store 108.

Although FIG. 1 illustrates a particular arrangement of communication device 101, communication device 102, communication device 103, network 105, server 107, data store 108 or platform 110, among other things, this disclosure contemplates any suitable arrangement. The devices of system 100 may be physically or logically co-located with each other in whole or in part.

It should be pointed out that although FIG. 1 shows one platform 110, server 107, data store 108 and three communication devices 101, 102, and 103, any suitable number of platforms 110, communication devices 101, 102, 103, servers 107, and data stores 108 may be part of the system 100 of FIG. 1 without departing from the spirit and scope of the present disclosure.

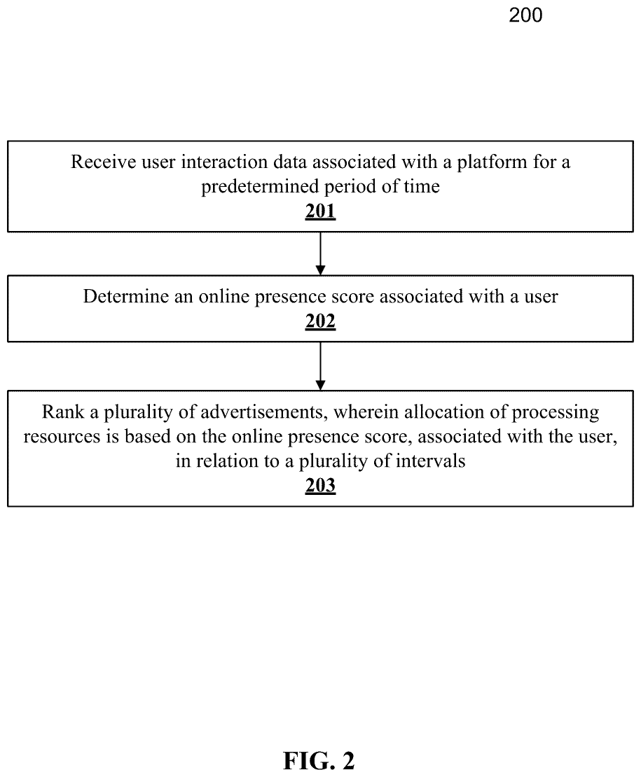

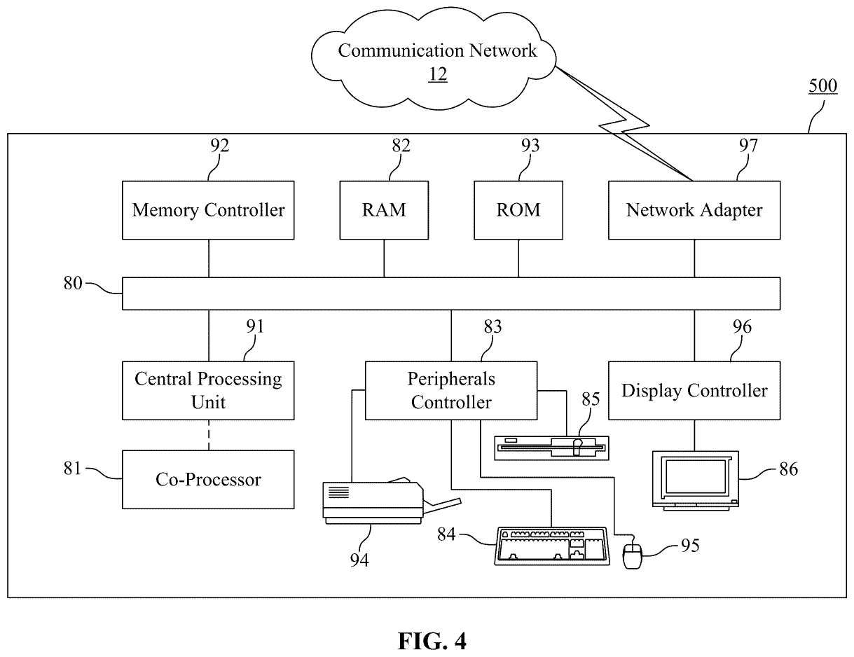

FIG. 2 shows an example method. The method 200 may comprise a computer implemented method for allocating processing power for ranking content (e.g., advertisements, or the like). A system and/or computing environment, such as the system 100 of FIG. 1 or the computing environment of FIG. 4, may be configured to perform the method 200. The method 200 may be performed in connection with the system illustrated in FIG. 1. Any step or combination of steps of the method 200 may be performed by a computing device, network device, network node, server and/or user device, such as any of the devices shown in FIG. 1.

The method 200 may begin at step 201, where user interaction data associated with a platform (e.g., platform 110) may be received. User interaction data may be captured by tracking user interactions with content items produced, via platform 110. User interaction data may include but is not limited to time an advertisement is displayed on a user device (e.g., detecting eye gaze in a combination with what is displayed on the user device over a period, determining a period at which what is displayed without further device interaction (e.g., scrolling, clicking, or the like), or any other suitable method), click through rate, number of account followers, number of advertisement clicks, interactions with posts, or any other suitable interaction with content items of platform 110.

In some examples, the user interaction data may be sent on a network (e.g., network 105) to a server (e.g., server 107). User interaction data may begin to be tracked based on user interactions from a user with content items associated with the platform 110. In some examples, user interaction data may be captured or updated on a continuous loop after a predetermined period of time. The predetermined period of time may be any suitable period of time. For example, user interaction data may be captured every seven days. In some examples, the user interaction data (e.g., user interaction information) may be stored in a database (e.g., data store 108), a server (e.g., server 107), or any other suitable component of system 100.

At step 202, an online presence score associated with a user may be determined. The online presence score may be determined based on the user interaction data received. The user interaction data may be determined via a mathematical formula associated with data points that may constitute the user interactions data. In an example, portions of user interaction data may be weighted more heavily than other portions of user interaction data. For example, user interaction data associated with interactions with advertisements may have a larger influence on the online presence score determined. In some examples, the online presence score associated with a user may be stored in a database (e.g., data store 108), a server (e.g., server 107), or any other suitable component of system 100. In some examples, the online presence score may be utilized to infer or determine a potential monetary value associated with the user. As such a user associated with a higher online presence score may be determined a target user whereas a user associated with a low online presence score may indicate a nontarget user. A target user may be defined as one or more users of a plurality of users that may interact with content items associated with the platform, for example, the target user may be one or more users with an online presence score within the 90th percentile of a plurality of users' online presence score. Conversely, a nontarget user may be defined as one or more users of the plurality of users that may interact with content items associated with the platform where the one or more users' online presence score is low. For example, a nontarget user may be one or more users with an online presence score below the 20th percentile of the plurality of users' online presence score. It is contemplated that the target user and the nontarget user may be indicated by any suitable threshold percentile. A user (targeted or not targeted) may be associated with a user identifier.

At step 203, a plurality of advertisements may be ranked. The plurality of advertisements may be ranked based on the online presence score determined at step 202 in relation to a plurality of intervals. The plurality of intervals may correspond to a plurality of intervals of online presence scores, wherein one or more intervals of the plurality of intervals may correspond to a range of online presence scores determined for a plurality of users. In an example, one or more users of a plurality of users may be associated with a high online presence score, as such, the one or more users may be associated with a first interval of the plurality of intervals. The first interval may correspond to one or more online presence scores within a range that is the highest online scores in relation to a plurality online presence scores associated with a plurality of users. One or more users with online presence scores associated with the first interval may be considered (e.g., define) a target user. An online presence score(s) associated with the first interval may initiate more processing resource allocation for ranking advertisements, wherein the advertisements ranked may be related to the target user. For example, advertisement ranking associated with a user determined to have an online presence score associated with a first interval may be allocated more resources for ranking. In such an example, the advertisement ranking associated with the target user may utilize a majority of the total processing power available to an advertising system, associated with platform 110, for example, the target user may be allocated 80% of the maximum processing power associated with advertising system. As such, more advertisements that are relevant or deemed of interest to a target user may be ranked, thus generating more quality advertisements for users that may result in an increase in revenue for entities, the platform 110, or organizations.

In an example, one or more users of the plurality of users may be associated with a low online presence score, as such, the one or more users may be associated with a second interval of the plurality of intervals. The second interval may correspond to one or more online presence scores within a range that is the lowest online scores in relation to a plurality online presence scores associated with a plurality of users. One or more users with online presence scores associated with the second interval may be considered (e.g., define) a nontarget user. An online presence score(s) associated with the second interval may initiate less processing resources to be allocated to ranking advertisements, wherein the advertisements ranked may be related to the nontarget user. For example, advertisement ranking associated with a user determined to have an online presence score associated with the second interval may be allocated less resources for ranking. In such an example, the advertisement ranking associated with the nontarget user may utilize a small percentage of the total processing power available to an advertising system, associated with platform 110, for example, the nontarget user may be allocated 20% of the maximum processing power associated with advertising system. As such, less advertisements that are relevant or deemed of interest to a nontarget user may be ranked than what may be ranked in conventional advertisement ranking systems. As such, less resources are allocated to users (e.g., nontarget users) that may not have a high potential of purchasing a product or item associated with advertisements. Thus, processing power may be optimized for target users such that the platform 110 may provide an quality advertising experience to users that may utilize or purchase more from the platform 110.

Advertisements may be ranked, via a machine learning model, based on a combination of factors that may optimize user engagement and advertiser goals. The ranking process may involve evaluating advertisements using algorithms that may consider one or more of relevance, user interest, bid amounts associated with an entities advertisement, quality scores, or any other suitable, information. User interest may be determined based on user interactions with content items associated with a platform (e.g., platform 110). In an example, user interest may include analyzing one or more portions of content items to determine an interest profile associated with the user. In some examples, the user interest may be associated with a user profile. Relevance may be determined by how closely an advertisement matches the user's interests and search queries. Bid amounts may reflect the maximum amount advertisers are willing to pay for advertisement placements. Quality scores may assess the overall user experience, including advertisement click-through rates and landing page quality. Advertisements with higher rankings may be displayed in more prominent positions, such as a foreground of applications or platforms, ensuring maximum visibility. Conversely, lower-ranked ads may be placed in less prominent positions, such as a background, where they receive less attention.

The foreground may refer to the most prominent and visible areas of platform 110 where advertisements may be displayed. The foreground may be synonymous with areas of the platform 110 where users are more likely notice an advertisement and interact with the advertisement. For example, the foreground may be associated with an advertisement at the top of a webpage,, the main feed of a social media platform, or the primary screen of a mobile app. Advertisements placed in the foreground may be given priority due to their high visibility and potential for user engagement.

The background may refer to less prominent areas of platform 110 where advertisements may be displayed with lower visibility. The background may be synonymous with areas of the platform 110 where users are less likely to notice an advertisement and interact with the advertisement. For example, the background may be associated with an advertisement at the sidebars, footers, secondary screens, or any area that users may not focus on Advertisements placed in the background are still visible but may be less likely to attract immediate attention compared to those in the foreground. The distinction between foreground and background may help strategically placing ads to maximize their effectiveness based on their ranking and relevance.

However, in the present disclosure more ads may be ranked due to the number of advertisements being assessed for the plurality of users. For example, the two extremes (e.g., the first interval and the second interval) of the online presence scores associated with the plurality of users may be determined. As such, a subset of the plurality of users may indicate which advertisements may be ranked. As a result, more computing or processing power may be available to assess and rank advertisements related to nontarget users and target users (e.g., the two extremes). As such, X number of advertisements may be added to conventional advertisement systems such that more advertisements may be ranked. Since more resources are allocated to target users for advertisement ranking in the background and the foreground, the advertisements generated for users may be more relevant to users with a high purchasing potential (e.g., target users). As a result, user experience associated with the platform 110 may be improved as well as increased advertisement revenue for advertisers and entities associated with the platform 110.

It is contemplated that the method 200 may not utilize the plurality of intervals as described, instead a mathematical expression or equation may be utilized to determine how to allocate system resources such that more resources are allocated to target users. The use of a mathematical expression or equation may also take into the totality of the plurality of users associated with the platform, as readily apparent by those skilled in the art. It is contemplated that the term “a user,” may refer to one or more users of a plurality of users associated with a platform (e.g., platform 110), wherein the one or more users of the plurality of users may utilize the platform via one or more user devices (e.g., devices 101, 102, 103).

Although FIG. 2 illustrates example steps of the method 200, in some examples, the method 200 may include additional steps, fewer steps, different steps, or different arranged steps than those depicted in FIG. 2, additionally, or alternatively, two or more steps of the method 200 may be performed in parallel.

FIG. 3 illustrates a block diagram of an example hardware/software architecture of user equipment (UE) 30. As shown in FIG. 3, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 is a smart camera configured to sense images appearing within one or more bounding boxes. The UE 30 may also include communication circuitry, such as a transceiver 34 and a transmit/receive element 36. It will be appreciated that the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another example, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

FIG. 4 is a block diagram of an exemplary computing system 500. In some exemplary embodiments, the platform 110 may be a computing system 500. The computing system 500 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 500 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 500 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 500 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 500. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 500 may contain communication circuitry, such as for example a network adaptor 97, that may be used to connect computing system 500 to an external communications network, such as network 21 of FIG. 3, to enable the computing system 500 to communicate with other nodes (e.g., UE 30) of the network.

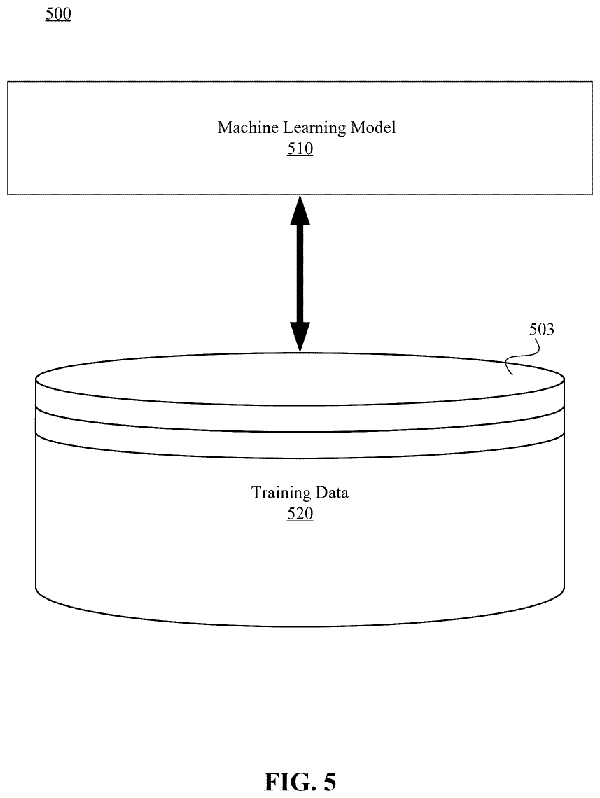

FIG. 5 illustrates a framework 500 that may be employed by the platform 110 associated with machine learning for ranking advertisements. The framework 500 may be hosted remotely. Alternatively, the framework 500 may reside within the system 100 shown in FIG. 1 or be processed by a device (e.g., device 101, 102, 103). In some examples, the machine learning model 510 may be implemented by a server (e.g., server 107), or a platform (e.g., platform 110). In other examples, the machine learning model 510 may be implemented by other devices (e.g., communication devices 101, 102, 103). The machine learning model 510 may be operably coupled with the stored training data in a training database 503 (e.g., data store 108). In some examples, the machine learning model 510 may be associated with other operations. The machine learning model 510 may be one or more machine learning models.

In another example, the training data 520 may include attributes of thousands of objects. For example, the objects may be a smart phone, person, book, newspaper, sign, car, item, and/or the like. Attributes may include but are not limited to the size, shape, orientation, position of the object(s), etc. The training data 520 employed by the machine learning model 510 may be fixed or updated periodically. Alternatively, the training data 520 may be updated in real-time based upon the evaluations performed by the machine learning model 510 in a non-training mode. This is illustrated by the double-sided arrow connecting the machine learning model 510 and stored training data 520.

In operation, the machine learning model 510 may evaluate associations between an online presence and advertisement ranking. For example, a target user may be initiate ranking of advertisements of interest compared with respective attributes of stored training data 520 (e.g., prestored objects) to generate an advertisement of interest to the target user.

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, elements and features described in connection with any one or more examples are not intended to be excluded from a similar role in any other examples. It is contemplated that methods may apply to the user or to the group.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

Some portions of this description describe the examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one example, a software module is implemented with a computer program product comprising a computer-readable medium containing computer program code, which can be executed by a computer processor for performing any or all of the steps, operations, or processes described.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Examples also may relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples also may relate to a product that is produced by a computing process described herein. Such a product may comprise information resulting from a computing process, where the information is stored on a non-transitory, tangible computer readable storage medium and may include any example of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

### B. Efficient Depth Stabilizer for Augmented Reality-Mixed Reality

### BACKGROUND

Depth estimation is a fundamental task for AR and MR applications. Depth estimation is the basis for features such as 3D reconstruction, passthrough, occlusion, smart guardian, and the like. One key requirement for depth estimation is temporal consistency. Traditional deep temporal depth models are too complex to run in augmented reality/mixed reality (AR/MR) headsets or similar devices. Instead these deep models tend to be run via a cloud network (e.g., one or more cloud servers). However, sending data through the cloud network to be processed, and then sending output back to the AR/MR devices significantly increase latency within the system. There are currently no available light weight models that can achieve depth estimation with sufficient temporal stability.

### SUMMARY

A novel architecture is described in one or more aspects of the subject application that enables a lightweight model for depth estimation for AR/MR systems. The lightweight model may combine current depth estimations and previous depth estimation history to achieve stabilized depth estimation. The lightweight model may separate dynamic and static objects, which may provide for effective depth estimation in both static and dynamic scenes. The lightweight model may be configured to be small and efficient (e.g., power of 30 milliwatt (mW) and 1 millisecond (ms) of latency), which may allow for the lightweight model to reside in a corresponding AR/MR device or headset. Further, the light weight model may provide for improved temporal stability compared to other conventional depth estimation models.

The subject application is at least directed to methods and systems for a lightweight model for depth estimation for AR/MR systems. The lightweight model may combine current depth estimations and previous depth estimation history to achieve stabilized depth estimation. The lightweight model may separate dynamic and static objects, which may provide for effective depth estimation in both static and dynamic scenes.

### DETAILED DESCRIPTION

Some examples of the subject technology will now be described more fully hereinafter with reference to the accompanying drawings, in which some, but not all examples of the subject technology are shown. Indeed, various examples of the subject technology may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

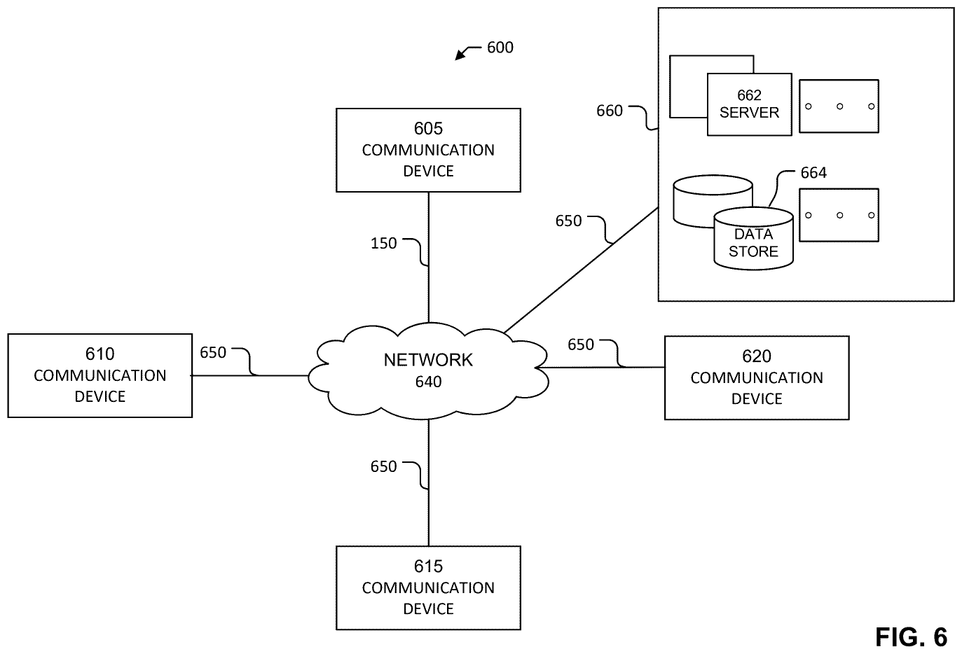

Reference is now made to FIG. 6, which is a block diagram of a system according to exemplary embodiments. As shown in FIG. 6, the system 600 may include one or more communication devices 605, 610, 615 and 620 and a network device 660. Additionally, the system 600 may include any suitable network such as, for example, network 640. In some examples, the network 640. In other examples, the network 640 may be any suitable network capable of provisioning content and/or facilitating communications among entities within, or associated with the network 640. As an example and not by way of limitation, one or more portions of network 640 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 640.

Links 650 may connect the communication devices 605, 610, 615 and 620 to network 640, network device 660 and/or to each other. This disclosure contemplates any suitable links 650. In some exemplary embodiments, one or more links 650 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 650 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout system 600. One or more first links 650 may differ in one or more respects from one or more second links 650.

In some exemplary embodiments, communication devices 605, 610, 615, 620 may be electronic devices including hardware, software, or embedded logic components or a combination of two or more such components and capable of carrying out the appropriate functionalities implemented or supported by the communication devices 605, 610, 615, 620. As an example, and not by way of limitation, the communication devices 605, 610, 615, 620 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 605, 610, 615, 620 may enable one or more users to access network 640. The communication devices 605, 610, 615, 620 may enable a user(s) to communicate with other users at other communication devices 605, 610, 615, 620.

Network device 660 may be accessed by the other components of system 600 either directly or via network 640. As an example and not by way of limitation, communication devices 605, 610, 615, 620 may access network device 660 using a web browser or a native application associated with network device 660 (e.g., a mobile social-networking application, a messaging application, another suitable application, or any combination thereof) either directly or via network 640. In particular exemplary embodiments, network device 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 662 may include hardware, software, or embedded logic components or a combination of two or more such components for carrying out the appropriate functionalities implemented and/or supported by server 662. In particular exemplary embodiments, network device 660 may include one or more data stores 664. Data stores 664 may be used to store various types of information. In particular exemplary embodiments, the information stored in data stores 664 may be organized according to specific data structures. In particular exemplary embodiments, each data store 664 may be a relational, columnar, correlation, or other suitable database. Although this disclosure describes or illustrates particular types of databases, this disclosure contemplates any suitable types of databases. Particular exemplary embodiments may provide interfaces that enable communication devices 605, 610, 615, 620 and/or another system (e.g., a third-party system) to manage, retrieve, modify, add, or delete, the information stored in data store 664.

Network device 660 may provide users of the system 600 the ability to communicate and interact with other users. In particular exemplary embodiments, network device 660 may provide users with the ability to take actions on various types of items or objects, supported by network device 660. In particular exemplary embodiments, network device 660 may be capable of linking a variety of entities. As an example and not by way of limitation, network device 660 may enable users to interact with each other as well as receive content from other systems (e.g., third-party systems) or other entities, or allow users to interact with these entities through an application programming interfaces (API) or other communication channels.

It should be pointed out that although FIG. 6 shows one network device 660 and four communication devices 605, 610, 615 and 620, any suitable number of network devices 660 and communication devices 605, 610, 615 and 620 may be part of the system of FIG. 6 without departing from the spirit and scope of the present disclosure.

### Exemplary Communication Device

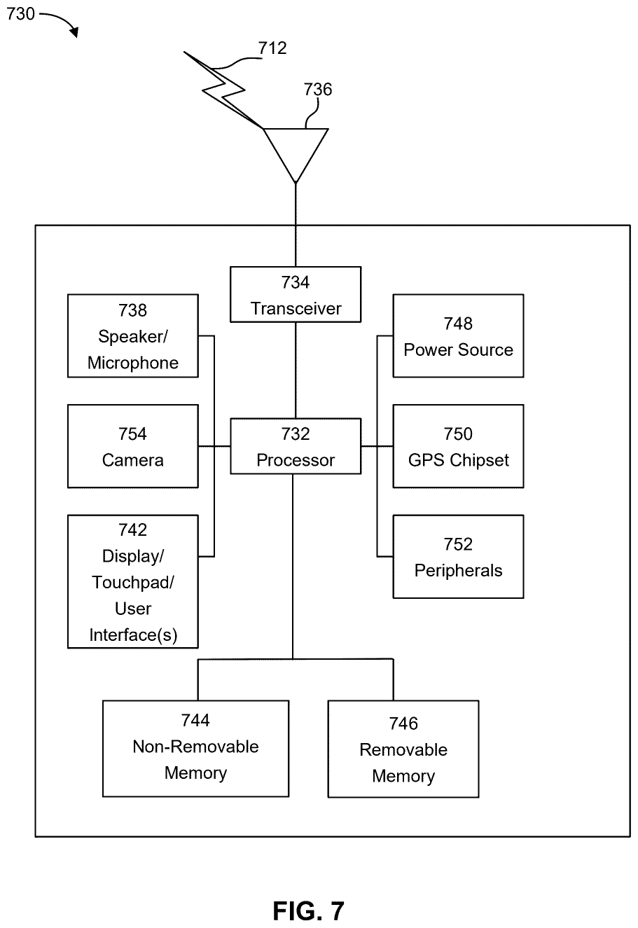

FIG. 7 illustrates a block diagram of an exemplary hardware/software architecture of a communication device such as, for example, user equipment (UE) 730. In some exemplary respects, the UE 730 may be any of communication devices 605, 610, 615, 620. In some exemplary aspects, the UE 730 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 7, the UE 730 (also referred to herein as node 730) may include a processor 732, non-removable memory 744, removable memory 746, a speaker/microphone 738, a display, touchpad, and/or user interface(s) 742, a power source 748, a GPS chipset 750, and other peripherals 752. In some exemplary aspects, the display, touchpad, and/or user interface(s) 742 may be referred to herein as display/touchpad/user interface(s) 742. The display/touchpad/user interface(s) 742 may include a user interface capable of presenting one or more content items and/or capturing input of one or more user interactions/actions associated with the user interface. The power source 748 may be capable of receiving electric power for supplying electric power to the UE 730. For example, the power source 748 may include an alternating current to direct current (AC-to-DC) converter allowing the power source 748 to be connected/plugged to an AC electrical receptacle and/or Universal Serial Bus (USB) port for receiving electric power. The UE 730 may also include a camera 754. In an exemplary embodiment, the camera 754 may be a smart camera configured to sense images/video appearing within one or more bounding boxes. The UE 730 may also include communication circuitry, such as a transceiver 734 and a transmit/receive element 736. It will be appreciated the UE 730 may include any sub-combination of the foregoing elements while remaining consistent with an embodiment.

The processor 732 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 732 may execute computer-executable instructions stored in the memory (e.g., non-removable memory 744 and/or removable memory 746) of the node 730 in order to perform the various required functions of the node. For example, the processor 732 may perform signal coding, data processing, power control, input/output processing, and/or any other functionality that enables the node 730 to operate in a wireless or wired environment. The processor 732 may run application-layer programs (e.g., browsers) and/or radio access-layer (RAN) programs and/or other communications programs. The processor 732 may also perform security operations such as authentication, security key agreement, and/or cryptographic operations, such as at the access-layer and/or application layer for example. The non-removable memory 744 and/or the removable memory 746 may be computer-readable storage mediums. For example, the non-removable memory 744 may include a non-transitory computer-readable storage medium and a transitory computer-readable storage medium.

The processor 732 is coupled to its communication circuitry (e.g., transceiver 734 and transmit/receive element 736). The processor 732, through the execution of computer-executable instructions, may control the communication circuitry in order to cause the node 730 to communicate with other nodes via the network to which it is connected.

The transmit/receive element 736 may be configured to transmit signals to, or receive signals from, other nodes or networking equipment. For example, in an exemplary embodiment, the transmit/receive element 736 may be an antenna configured to transmit and/or receive radio frequency (RF) signals. The transmit/receive element 736 may support various networks and air interfaces, such as wireless local area network (WLAN), wireless personal area network (WPAN), cellular, and the like. In yet another exemplary embodiment, the transmit/receive element 736 may be configured to transmit and/or receive both RF and light signals. It will be appreciated that the transmit/receive element 736 may be configured to transmit and/or receive any combination of wireless or wired signals.

The transceiver 734 may be configured to modulate the signals that are to be transmitted by the transmit/receive element 736 and to demodulate the signals that are received by the transmit/receive element 736. As noted above, the node 730 may have multi-mode capabilities. Thus, the transceiver 734 may include multiple transceivers for enabling the node 730 to communicate via multiple radio access technologies (RATs), such as universal terrestrial radio access (UTRA) and Institute of Electrical and Electronics Engineers (IEEE 802.11), for example.

The processor 732 may access information from, and store data in, any type of suitable memory, such as the non-removable memory 744 and/or the removable memory 746. For example, the processor 732 may store session context in its memory, (e.g., non-removable memory 44 and/or removable memory 746) as described above. The non-removable memory 744 may include RAM, ROM, a hard disk, or any other type of memory storage device. The removable memory 746 may include a subscriber identity module (SIM) card, a memory stick, a secure digital (SD) memory card, and the like. In other exemplary embodiments, the processor 732 may access information from, and store data in, memory that is not physically located on the node 730, such as on a server or a home computer.

The processor 732 may receive power from the power source 748 and may be configured to distribute and/or control the power to the other components in the node 730. The power source 748 may be any suitable device for powering the node 730. For example, the power source 748 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 732 may also be coupled to the GPS chipset 750, which may be configured to provide location information (e.g., longitude and latitude) regarding the current location of the node 730. It will be appreciated that the node 730 may acquire location information by way of any suitable location-determination method while remaining consistent with an exemplary embodiment.

### Exemplary Computing System

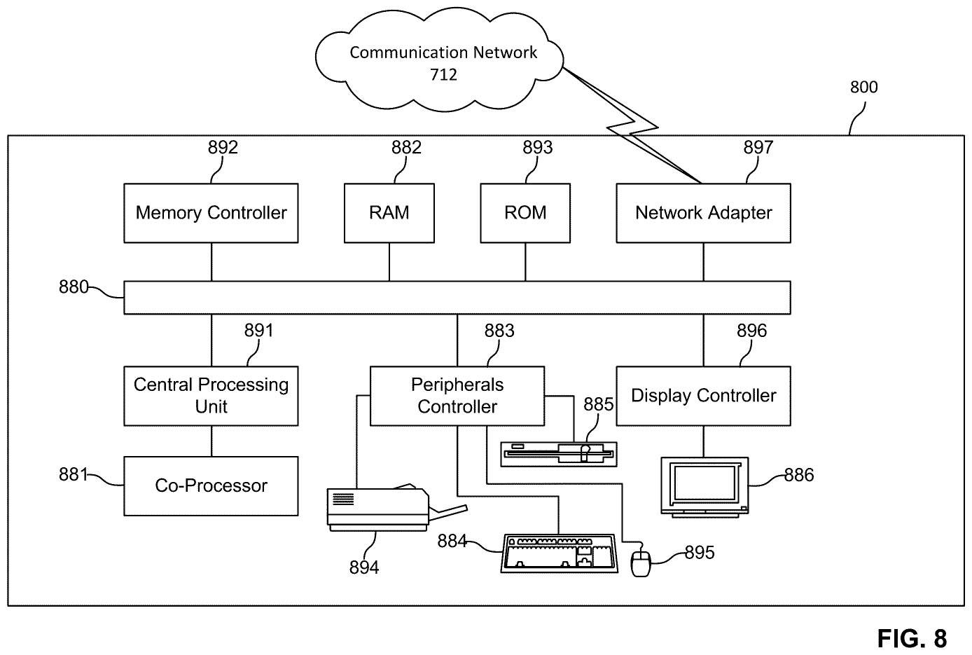

FIG. 8 is a block diagram of an exemplary computing system 800. In some exemplary embodiments, the network device 660 may be a computing system 800. The computing system 800 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 891, to cause computing system 800 to operate. In many workstations, servers, and personal computers, central processing unit 891 may be implemented by a single-chip CPU called a microprocessor. In other machines, the central processing unit 891 may comprise multiple processors. Coprocessor 881 may be an optional processor, distinct from main CPU 891, that performs additional functions or assists CPU 891.

In operation, CPU 891 fetches, decodes, and executes instructions, and transfers information to and from other resources via the computer's main data-transfer path, system bus 880. Such a system bus connects the components in computing system 800 and defines the medium for data exchange. System bus 880 typically includes data lines for sending data, address lines for sending addresses, and control lines for sending interrupts and for operating the system bus. An example of such a system bus 80 is the Peripheral Component Interconnect (PCI) bus.

Memories coupled to system bus 880 include RAM 882 and ROM 893. Such memories may include circuitry that allows information to be stored and retrieved. ROMs 893 generally contain stored data that cannot easily be modified. Data stored in RAM 882 may be read or changed by CPU 891 or other hardware devices. Access to RAM 882 and/or ROM 893 may be controlled by memory controller 892. Memory controller 892 may provide an address translation function that translates virtual addresses into physical addresses as instructions are executed. Memory controller 892 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 800 may contain peripherals controller 883 responsible for communicating instructions from CPU 891 to peripherals, such as printer 894, keyboard 884, mouse 895, and disk drive 885.

Display 886, which is controlled by display controller 896, may be used to display visual output generated by computing system 800. Such visual output may include text, graphics, animated graphics, and video. The display 886 may also include or be associated with a user interface. The user interface may be capable of presenting one or more content items and/or capturing input of one or more user interactions associated with the user interface. Display 886 may be implemented with a cathode-ray tube (CRT)-based video display, a liquid-crystal display (LCD)-based flat-panel display, gas plasma-based flat-panel display, or a touch-panel. Display controller 896 includes electronic components required to generate a video signal that is sent to display 886.

Further, computing system 800 may contain communication circuitry, such as for example a network adapter 897, that may be used to connect computing system 800 to an external communications network, such as network 712 of FIG. 7, to enable the computing system 800 to communicate with other nodes (e.g., UE 830) of the network.

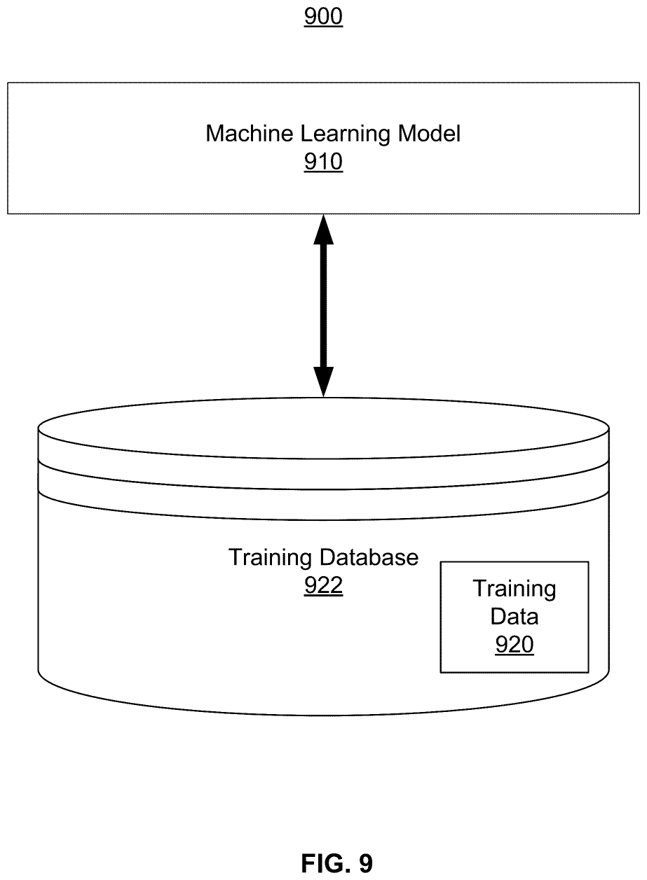

FIG. 9 illustrates a machine learning (ML) and training model, in accordance with an example of the present disclosure. The machine learning framework 900 associated with the machine learning model may be hosted remotely. Alternatively, the machine learning framework 900 may reside within a server 662 shown in FIG. 6, or be processed by an electronic device (e.g., head mounted displays, smartphones, tablets, smartwatches, or any electronic device, such as communication device 605). The machine learning model 910 may be communicatively coupled to the stored training data 920 in a memory or database (e.g., ROM, RAM) such as training database 922. In some examples, the machine learning model 910 may be associated with operations of any one or more of the systems/architectures depicted in subsequent figures of the application. In some other examples, the machine learning model 910 may be associated with other operations. The machine learning model 910 may be implemented by one or more machine learning models(s) and/or another device (e.g., a server and/or a computing system). In some embodiments, the machine learning model 910 may be a student model trained by a teacher model, and the teacher model may be included in the training database 922.

### Depth Estimation Model

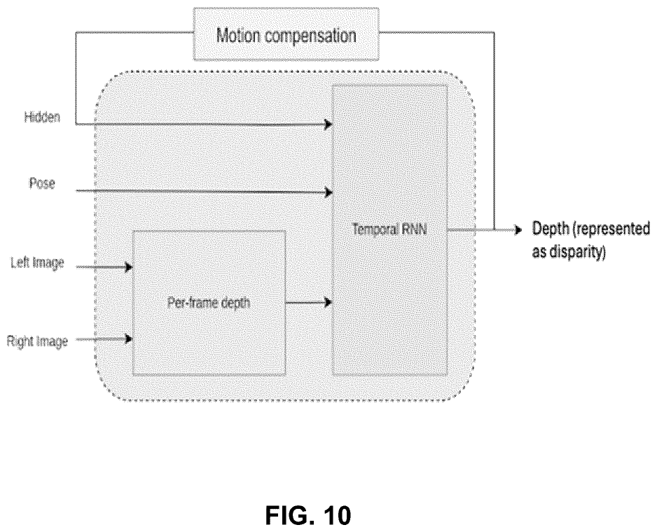

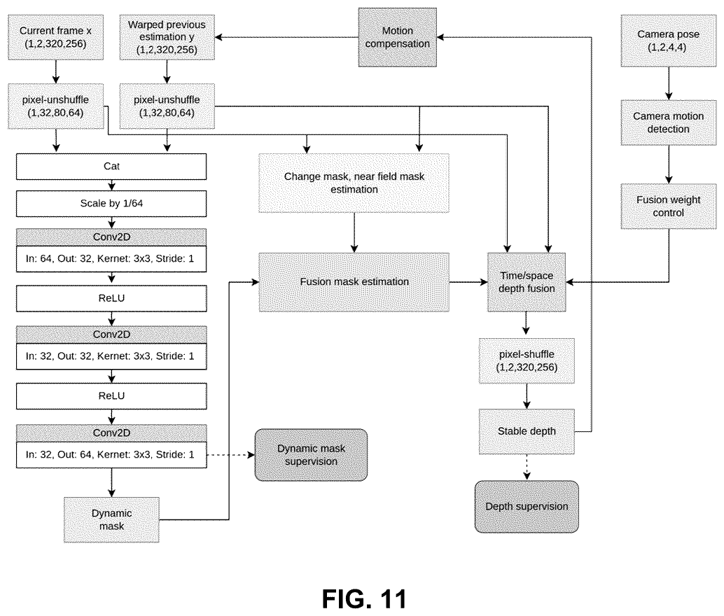

According to an aspect of the instant application, a system architecture may include an on-device ML model configured to provide a depth estimation for AR/MR video or images. The model may incorporate a per-frame model output (e.g., as shown in FIG. 10), motion compensated history, and camera poses as input. In some cases, inverse depth may represent depth. During motion compensation, camera pose information may be used to align the motion compensated history with the current viewpoint, thereby compensating for camera movement. The global motion compensation may be effective for static parts of a scene. The lightweight model may estimate a heatmap of dynamic objects, which may enable the lightweight model to separate dynamic and static objects in the scene at the pixel level. This may allow the model to effectively handle both static and dynamic scenes.

According to an aspect of the instant application, the depth estimation network may predict multiple heatmaps to control a combination of current depth and previous results. The dynamic object heatmap, such as for left and right views, may be estimated via a fully convolutional network. The input to the dynamic object estimation network may include a concatenation of a current depth map and a previous motion-compensated depth map. This may leverage the fact that global motion compensation is more effective for static regions of a scene than dynamic regions.

According to an aspect of the instant application, the network may employ semantics to differentiate between static and dynamic objects. For example, hands may be typically dynamic in a scene and may exhibit greater differences in motion-compensated frames.

According to an aspect of the instant application, the system may include a dynamic object network, which may include a limited number of convolution layers for depth estimation.

According to an aspect of the instant application, the system may also estimate a heatmap, which may identify areas of the scene that may be occluded.

According to an aspect of the instant application, the depth estimation and depth estimation history data may be combined based on the confidence of the depth estimations. For example, when a corresponding AR/MR headset moves slowly, the depth estimation history data may correspond to a higher confidence level, and vice versa. As a result, the weight of fusion may be increased when the AR/MR headset moves slowly to achieve more temporally consistent results.

According to an aspect of the instant application, the depth estimation network may be configured to be small and efficient. The network may employ several techniques to achieve high efficiency, such as improving the model graph by ordering operators to share computations, and implementing convolution techniques for pixel shuffle. For example, the network may organize computations as a pixel-unshuffle and shuffle pair. As another example, native pixel-unshuffle and shuffle data may be replaced with convolution and conv-transpose operations, where the sparse kernel of these convolutions provide for greater computational efficiency.

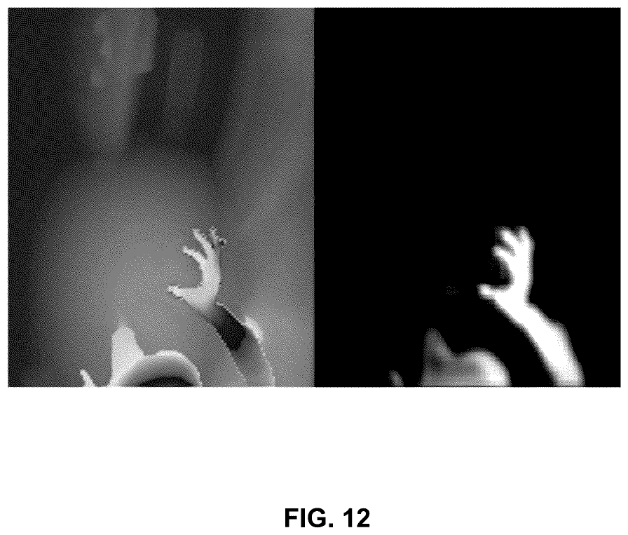

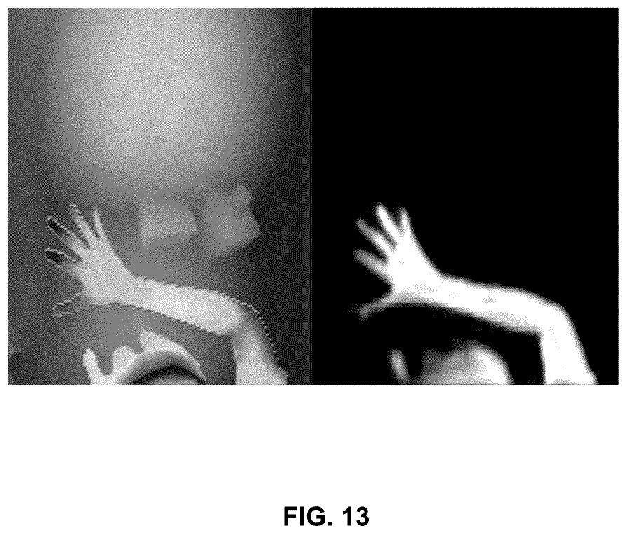

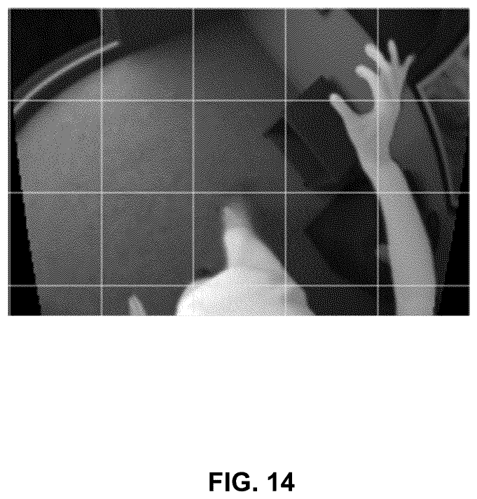

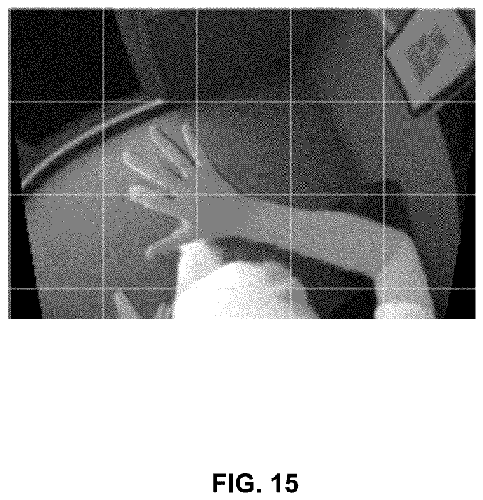

According to an aspect of the instant application, the system may incorporate a fully convolutional network architecture to differentiate between the dynamic and static components of a scene. This design may enhance the efficiency of the inference process employed by the system. FIGS. 12, 13, 14, and 15 demonstrate dynamic object probability maps generated by the network.

According to an aspect of the instant application, a shuffle-fully convolutional neural (FCN) network may be employed for dynamic object segmentation. The shuffle-FCN network may be configured for detailed fast object segmentation via a compact network. The shuffle-FCN network may provide high resolution segmentation even where pixel shuffle reduces feature resolution in the FCN network.

According to an aspect of the instant application, temporal stability may be enhanced by considering head movement of an AR/MR headset. The confidence in depth estimation may be influenced by head movement. When the head movement is minimal, the depth estimation history may be designated with a higher level of confidence, which may allow for an assignment of a greater weight in the fusion process. By adjusting the fusion weight based on the amount of head movement, temporal stability may be improved.

### Model Pipeline

According to an aspect of the instant application, the depth estimation may be supervised for both the depth output and the dynamic object heatmap. The dynamic object masks may include hands, body, other people, etc. The dynamic object network may utilize both semantics and dynamics, enabling network to generalize to other objects even though the network may be trained on a limited set of dynamic objects. Motion-compensated ground truth may be used as the history depth during training.

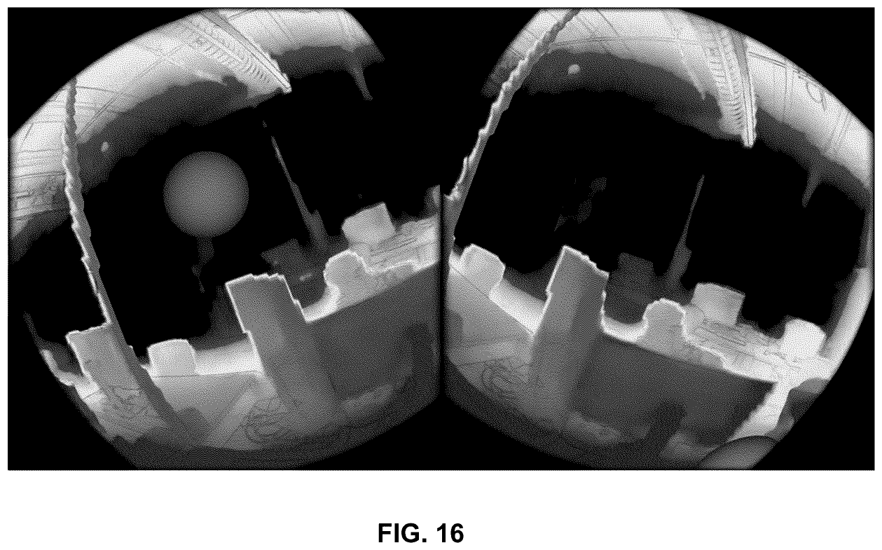

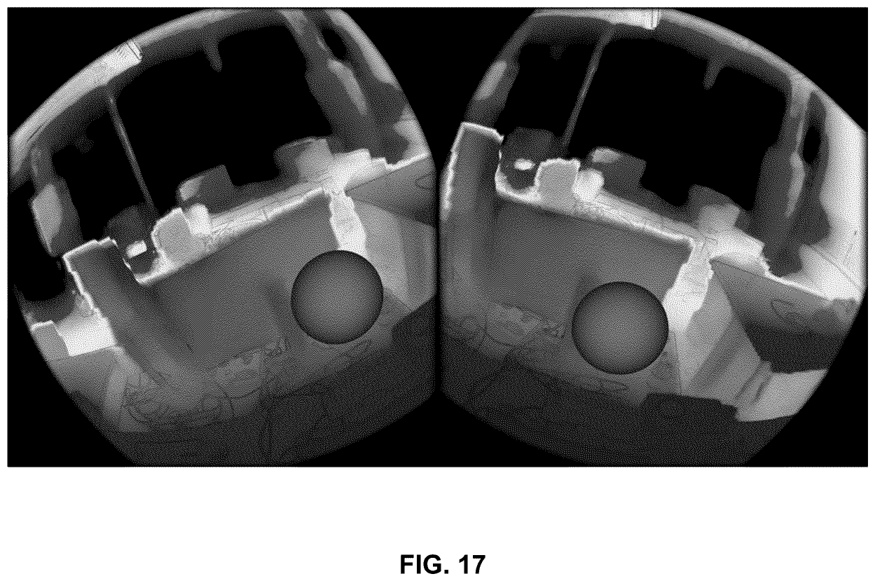

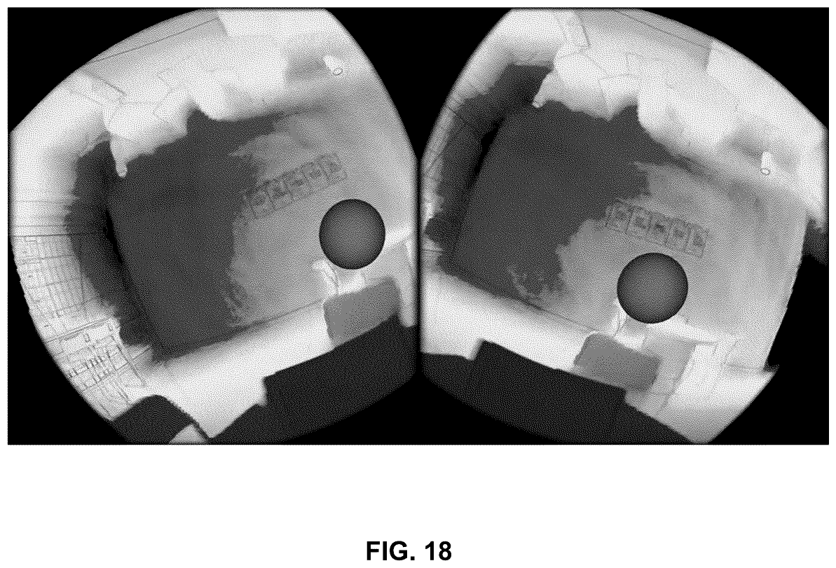

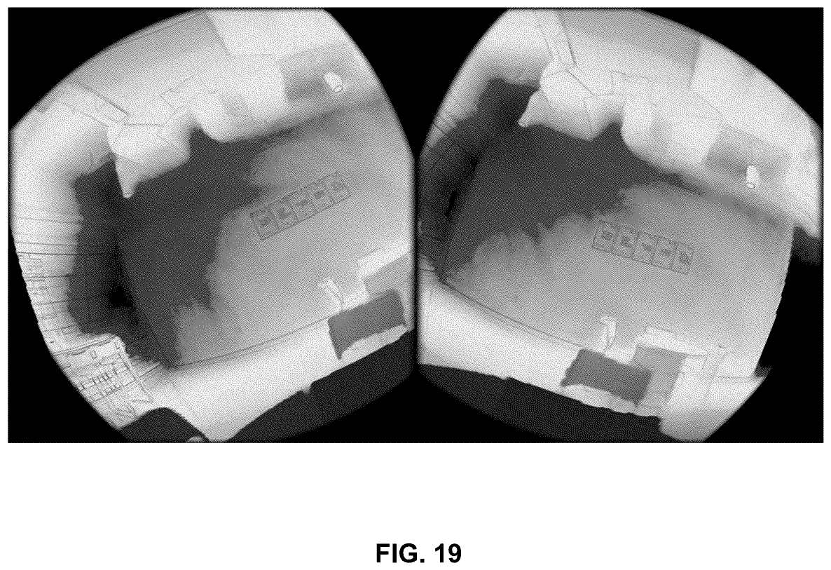

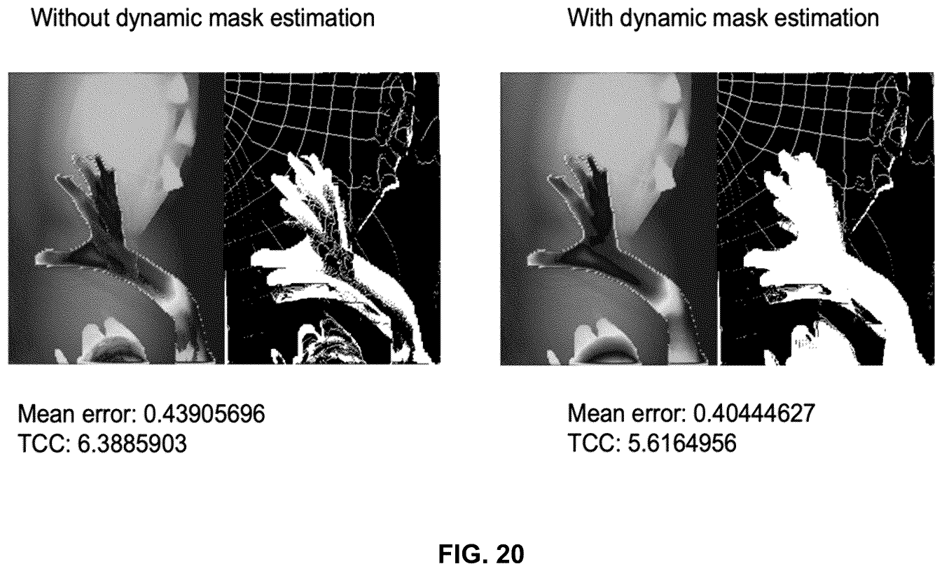

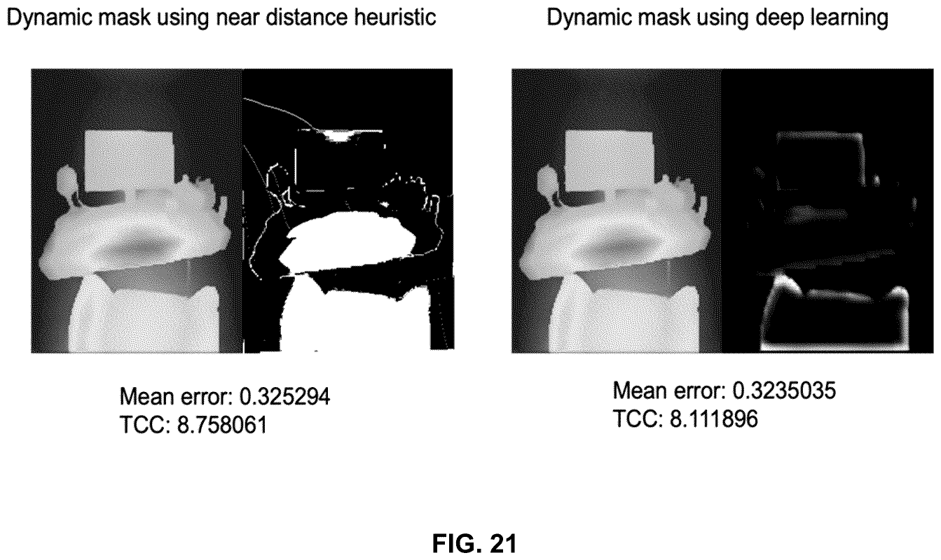

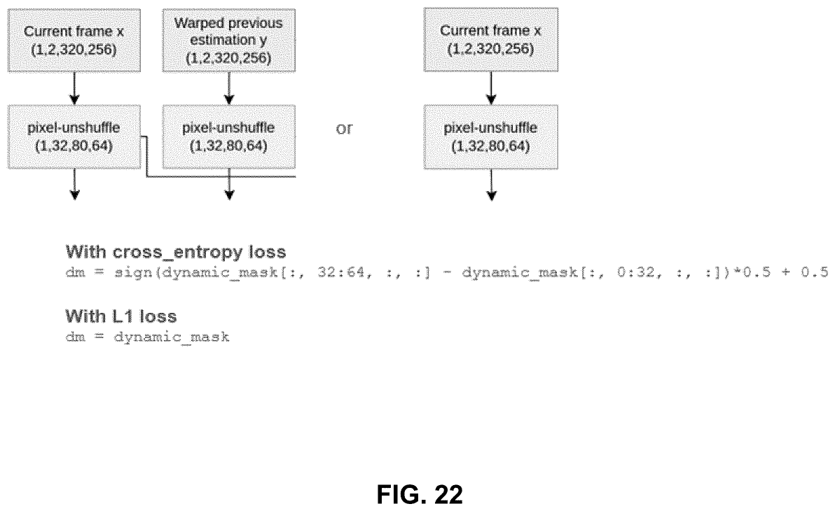

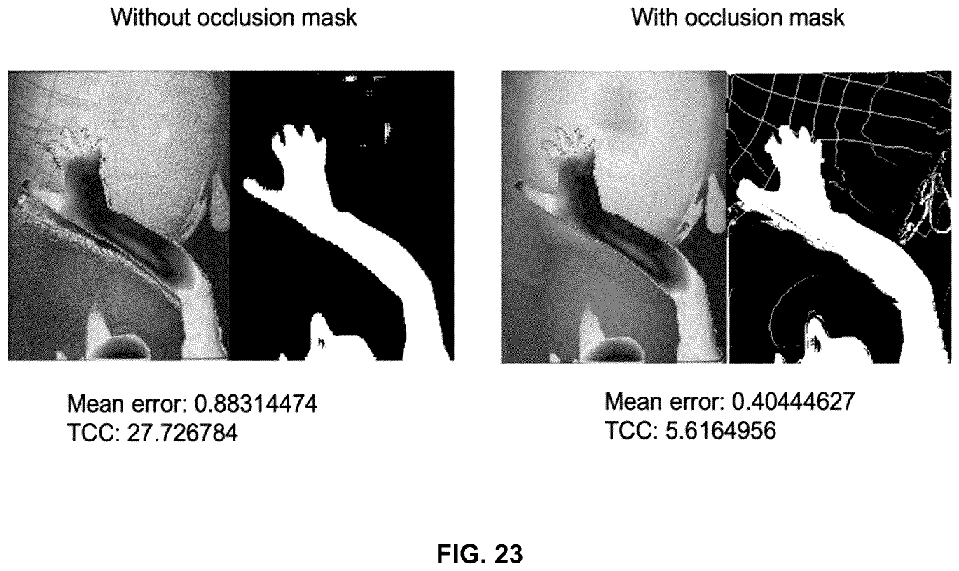

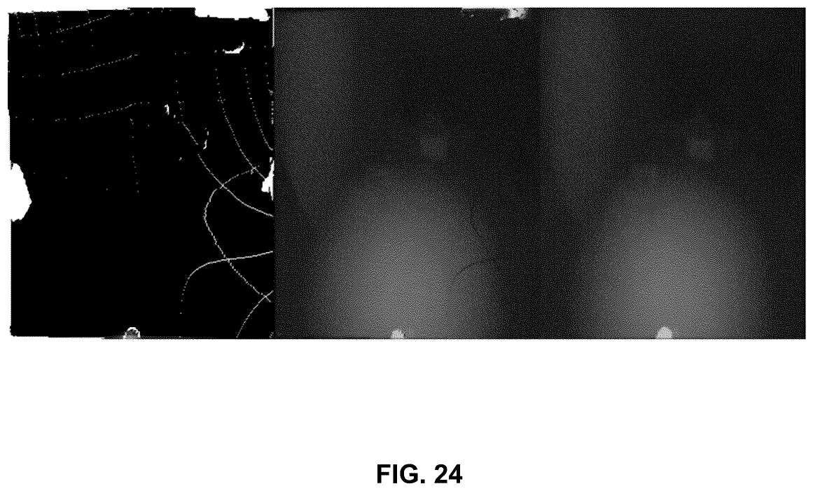

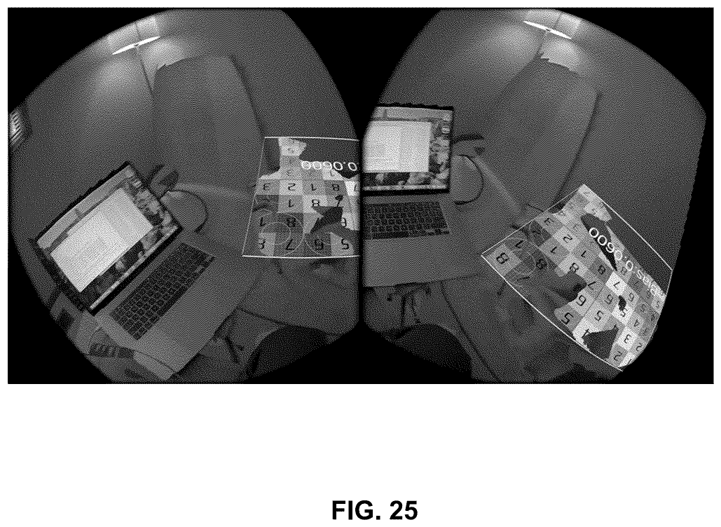

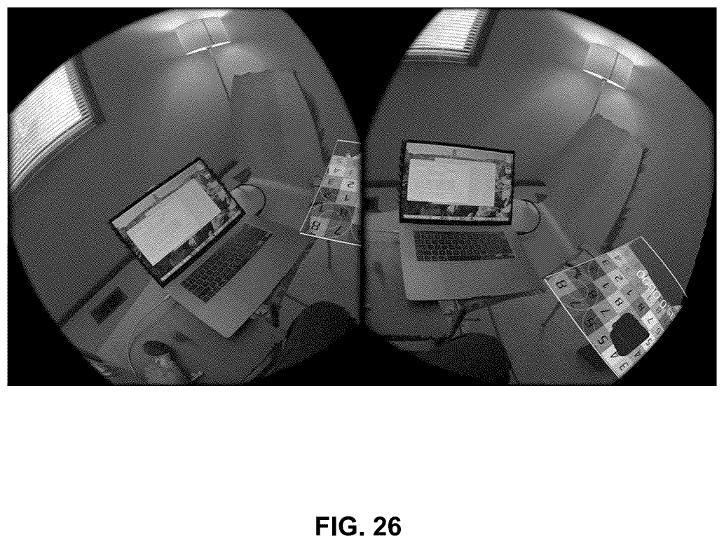

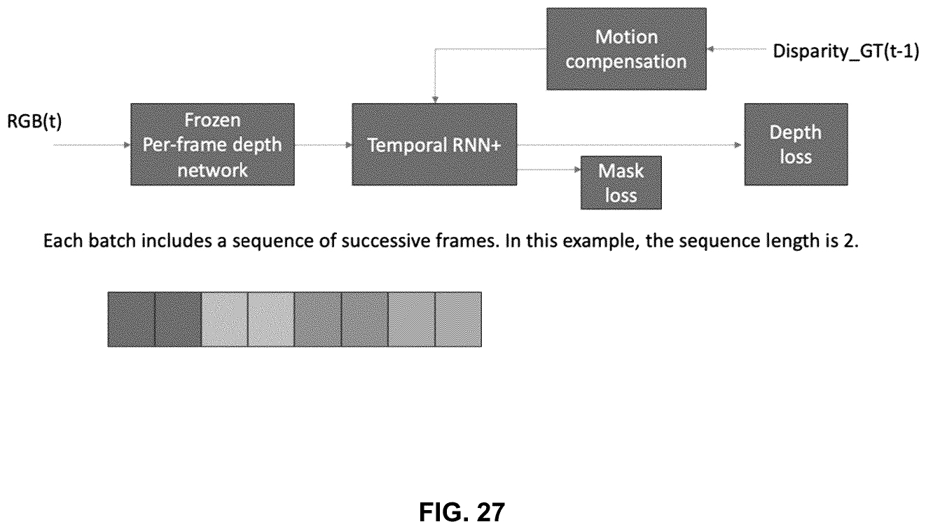

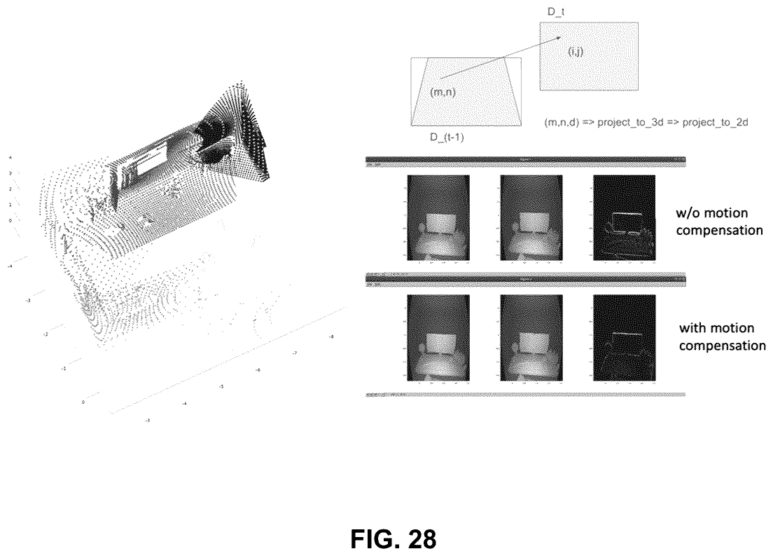

According to an aspect of the instant application, FIGS. 16, 17, 18, 19, 20, and 21 illustrate depth estimation maps implemented by the systems and devices described herein. FIG. 22 illustrates a dynamic mask estimation process that may be implemented by the systems and devices described herein. FIG. 23 illustrates a depth estimation and occlusion mask maps that may be implemented by the systems and devices described herein. FIG. 24 illustrates fusion mask maps in accordance with example aspects of the present disclosure. FIG. 25 illustrates control fusion weights based on head motion of a user, in accordance with example aspects of the present disclosure. FIG. 26 illustrates control fusion weights based on head motion of a user, in accordance with example aspects of the present disclosure. FIG. 27 illustrates a process for model training for depth estimation in accordance with example aspects of the present disclosure. FIG. 28 illustrates a diagram for motion compensation for depth estimation in accordance with example aspects of the present disclosure.

### Headset System

According to an aspect of the instant application, an AR/MR headset system may be configured to support motion compensation. Projecting subsampled disparity and resizing it to an original resolution may have minor impact on final depth quality. The system may use half subsampled disparity maps which are projected to the current frame and upsampled with the nearest neighbor interpolation as additional input to the model. Pose cached from the previous frame may be used to compute the change in pose and used as additional input to the model.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

### C. Time Based Insertion of Advertisements

### TECHNOLOGICAL FIELD

The present invention relates generally to advertising and more particularly to the methods or computer program systems for the insertion of advertisements on social media platforms.

### BACKGROUND

Social media platforms monetize customer engagement through advertisements, as companies and brands communicate product releases and upcoming projects to the general public through advertisements and they use social media as the medium by which to do so. Advertisements appear seamlessly throughout a social media content feed to effectively garner attention from the user while also careful not to distract the user from their selected content.

### BRIEF SUMMARY

The disclosed subject matter provides methods or computer program systems for optimizing the insertion of advertisements on a social media platform to communicate content to a social media user account available on any accessible device. In various examples, advertisements are inserted at specific times, personalized to the way in which a user interacts with the social media platform. This time-based insertion effectively balances need from the social media platform to advertise and by proxy generate revenue while also not sacrificing user engagement.

In one aspect, a method includes receiving, at a server, an advertisement to be delivered to user accounts; determining, based on the rate of consumption of the social media content measured for each user account, whether the user should receive the advertisement at a certain time interval or number of posts; delivering the advertisement to the user accounts; and having the timer feature reset in preparation of the next advertisement.

In another aspect, the timer feature starts upon the login of a user account on a social media platform; the timer measures the length of time recorded by the device to display each article of content and derives the average amount of time spent per post; upon the determination of the average time allocated to each article of content, the server compares that average to the general average time a generic user spends per post; and depending on the alignment to the average time allocated to each post, the server will insert advertisements to the social media platform feed associated with a user profile either after a pre-determined period of time or a pre-determined number of posts.

A method and computer program system for inserting advertisements seamlessly into a social media feed at specific times, personalized to the way in which a user engages with a social media platform. This time-based insertion effectively balances need from the social media platform to advertise and by proxy generate revenue while also not sacrificing quality of user engagement. Depending on the rate of consumption that a user processes content while on the social media platform, the length of time allocated per each article of content and how much content is displayed per each session, the algorithm will determine whether to insert advertisements after a pre-determined period of time or number of posts, to maximize the number of advertisements per session while not hampering the user experience.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DETAILED DESCRIPTION

Social media platforms insert advertisements amongst its feed to generate revenue from sponsorships. However, this approach may lead to a series of advertisements that overwhelm a content feed associated with a user profile on a social media platform, potentially causing frustration in the user and cutting engagement time and revenue for the social media platform unnecessarily short.

To address this issue, there may be a need for effective time-based insertion of advertisements to balance revenue generation of the social media platform, maximize the number of advertisements per session, whilst managing expectations of the user. Such a system may determine a non-offensive plan for inserting advertisements seamlessly throughout a content feed associated with a user profile, which may ensure that the user may engage with the social media platform without getting bombarded by or frustrated with the frequency of advertisements throughout their content feed.

The disclosed subject matter may strategically insert advertisements throughout a content feed associated with the user profile by measuring the ways in which a user engages with a social media platform, analyzing the average time allocated to each post, measured by the social media platform server, or determining whether the advertisement should be inserted after a pre-determined period of time or number of posts accordingly. The system may minimize user frustration, yield more revenue for the social media platform, or enhance the user experience.

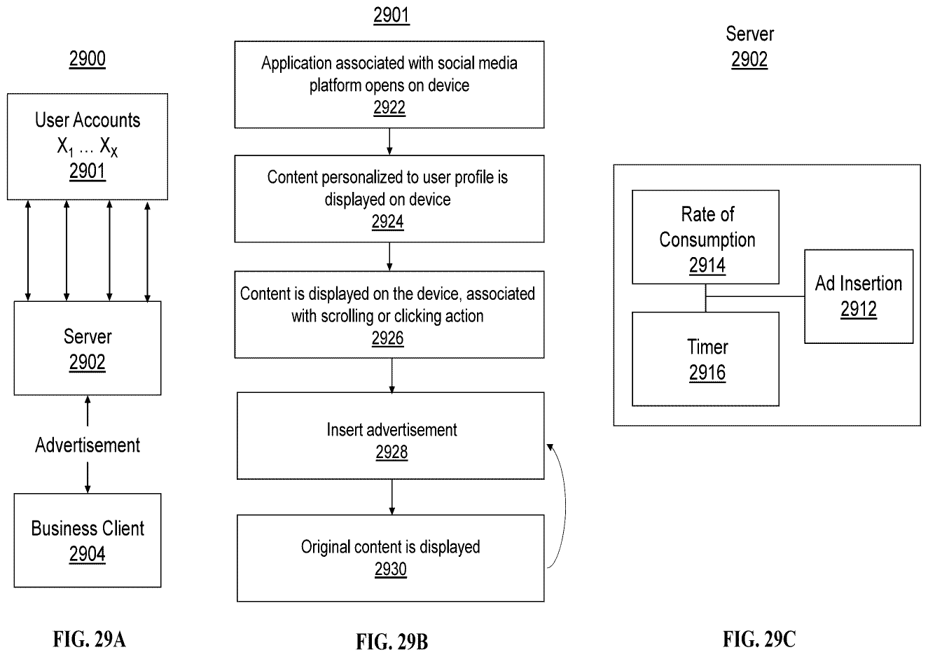

FIG. 29A illustrates an exemplary system 2900 for implementing the disclosed subject matter. The system 2900 may include a server 2902 connected with the population of social media platform user accounts 2901 (also referred herein as user profiles). Server 2902 may be connected with a business client function 2904. Business client function 2904 may send the advertisement to server 2902 for business client function 2904 to insert the advertisement according to the time rules derived by the server 2902 to each user account 2901 based on the advertisement insertion function 2912. The user accounts 2901 (e.g., one or more different user accounts) may be associated with the same social media platform to be accessed by different devices with network capability. These user accounts 2901 may communicate with the server 2902 via a communications network.

FIG. 29B illustrates a method by which the social media platform 2900 displays articles of content. A social media platform 2900 has multiple features to provide content to a user, whether it be via the story feature, the curated content feed, or the personalized discovery page. A social media platform 2900 may include a story feature, which may display real-time experiences in the form of an image, video, or chunk of text (hereafter referred to as content or articles of content). A social media platform 2900 may include a curated content feed, which may display content chosen by the user and organized by the server 2902. A social media platform 2900 may include a personalized discovery page, which displays in grid-form or as a list, content chosen and organized by the server based on the takeaways the server associates with the user profile.

At step 2922, the application associated with the social media platform 2900 may be executed on a network-enabled device associated with a user profile. To access the social media platform 2900 may be based on the use of a username and password. User account 2901 may connect with a social media platform 2900 via smart phone, desktop computer, tablet, etc. At step 2924, articles of content associated with a user profile may be displayed on a device as part of the content feed on the social media platform 2900. At step 2926, content is displayed on the device, associated with a scrolling or clicking action that is recorded by the device. The length of the scrolling action is measured in the background by the server 2902.

At step 2928, the business client function 2904 sends the targeted advertisement to be inputted by the server 2902 to be displayed in the content feed associated with the social media platform 2900. The advertisement is carefully incorporated within the content feed to blend within the other pieces of content but is marked as an “advertisement.” The advertisement is displayed at step 2928, and the social media platform resumes displaying the original content associated with the content feed associated with the user profile 2901 at step 30. After step 2930, content is displayed by the device until the server 2902 is alerted by the social media platform 2900 at a pre-determined interval, to be explained further below, to insert an advertisement into the content feed associated with the user profile 2901.

As shown in FIG. 29C, the server 2902 includes an advertisement insertion function 2912, a measure of the content consumption associated with a user profile 2914, or a timer 2916. The advertisement insertion function 2912 may be used to determine, based on the findings of the timer 2916 and the measure of the content consumption associated with a user profile 2914, whether the advertisement should be inserted after a pre-determined period of time or number of posts accordingly. For example, if each article of content is displayed by the social media platform 2900 on the device quickly, associated with a scrolling or clicking action, allocating less time per article of content than the determined average per post, the advertisement insertion function 2912 may opt to insert an advertisement after a pre-determined period of time. On the other hand, if each article of content is displayed by the social media platform 2900 on the device slowly, associated with a scrolling or clicking action, allocating more time per article of content than the determined average per post, the advertisement insertion function 2912 may insert an advertisement after a pre-determined number of posts. The measure of the content consumption associated with a user profile 2914 may capture the number of posts displayed in a session on a social media platform 2900. A session may capture the period of time an application associated with a social media platform is open on an able device. The timer 2916 measures how long a article of content is displayed on the device associated with the social media platform 2900. It is contemplated herein that one or more of the functionalities described herein may be executed on one device or module or distributed over multiple devices or modules.

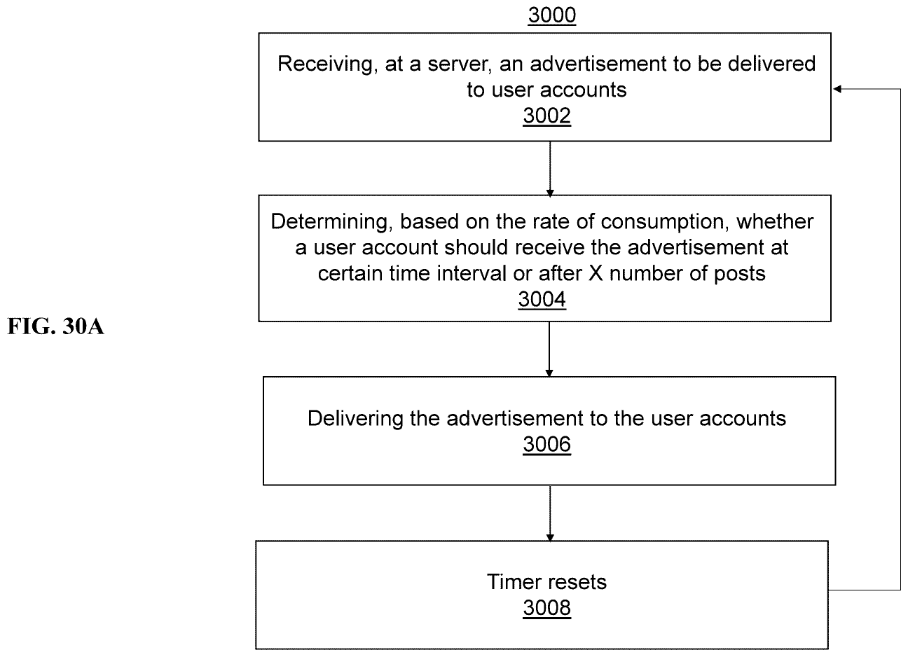

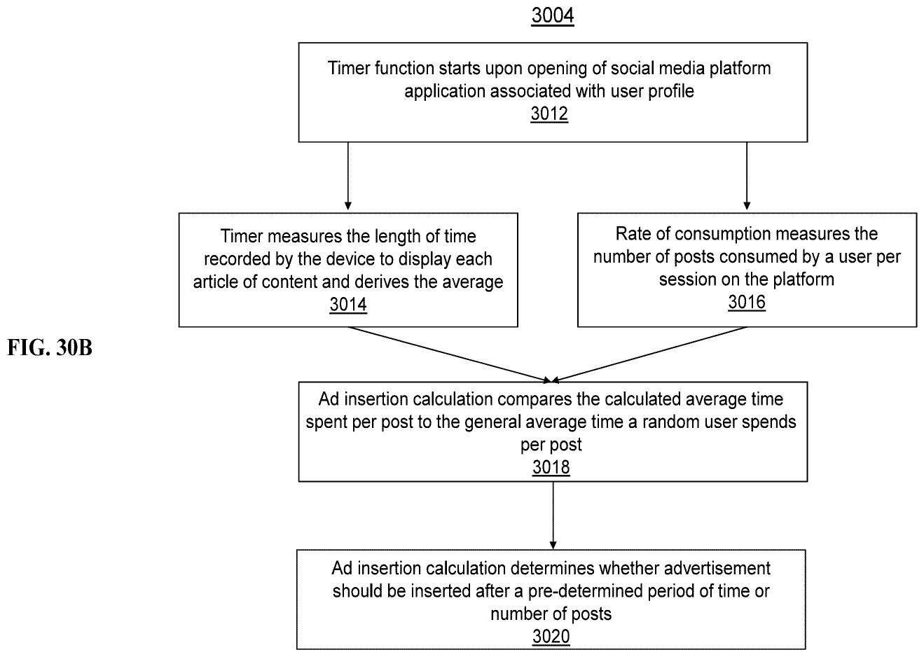

FIG. 30A illustrates a method 3000 for processing or delivering advertisements from a server perspective. At step 3002, the server 2902 may receive an advertisement to be delivered to the user accounts 2901. The advertisement may be created by the business client function 2904 and/or its public relations or advertising team. The advertisement may represent a feature of the business client or any third-party organization, brand, etc. The advertisement may resemble any other article of content in a social media feed associated with a user profile. In step 3004, the server 2902 may determine whether the advertisement should be inserted after a pre-determined period of time or number of posts accordingly. This determination may be based on various factors, which may be assessed by the advertisement insertion function 2912. The factors may include the speed at which the pieces of content are displayed as associated with the content feed, associated with a scrolling or clicking action, the length of time by which the pieces of content are displayed between scrolls or clicks, the length of time of a session on the social media platform, and prior engagement with the social media platform. The “time rule” is thus set at step 3004, to be further illustrated in FIG. 30B below.

Upon the derived time rule, the server 2902 may insert the advertisement at step 3006 into a social media feed associated with a user profile. The user accounts may be associated with the same social media platform and may belong to different people on the platform. One user account may be linked to any number of user devices (e.g., smartphones, tablets, desktop computers, etc.). At step 3008, the timer 2916 resets upon the insertion of the advertisement to zero to start recounting time spent per post, between advertisements, and engagement on the platform. It is contemplated that other devices may execute some or all of the disclosed steps herein.

FIG. 30B further illustrates the processes that may occur at step 204, in which the server 2902 may determine whether the advertisement may be inserted after a pre-determined period of time or number of posts accordingly. When the application associated with the social media platform 2900 associated with a user profile 2901 opens on network-abled device, the timer 2916 starts counting at step 3012. Step 3012 may occur once. Steps 3014 and 3016 occur simultaneously. The social media platform displays on the device, and the timer 2916 starts counting the length of the session, the length of time by which the pieces of content are displayed between scrolls or clicks, the length of time each article of content is displayed and determines the average length of time an article of content is displayed in step 3014. The measure of the content consumption associated with a user profile 2914 may count the articles of content displayed between scrolls or clicks and over the course of the session. At step 3018, the advertisement insertion function 2912 may compare the determined average time an article of content is displayed, as derived by the timer 2916, to the general average time spent per post by a generic user, to determine whether the server 2902 should base the time-based insertion of the advertisement on the timer 2916 or the measure of the content consumption associated with a user profile 2914 at step 3020.

The result of step 3020 may be whether the server 2902 may insert an advertisement into the social media feed after a pre-determined period of time or after a pre-determined number of posts. If the length of time each article of content is displayed is considered shorter, allocating less time than the determined average per post, the advertisement insertion function 2912 may opt to insert an advertisement after a pre-determined period of time. If the length of time each article of content is displayed is considered longer, allocating more time than the determined average per post, the advertisement insertion function 2912 may insert an advertisement after a pre-determined number of posts. After the advertisement is inserted into the feed, the timer 2916 may reset, as illustrated in FIG. 30A, to restart the process of inserting the next advertisement into the feed.

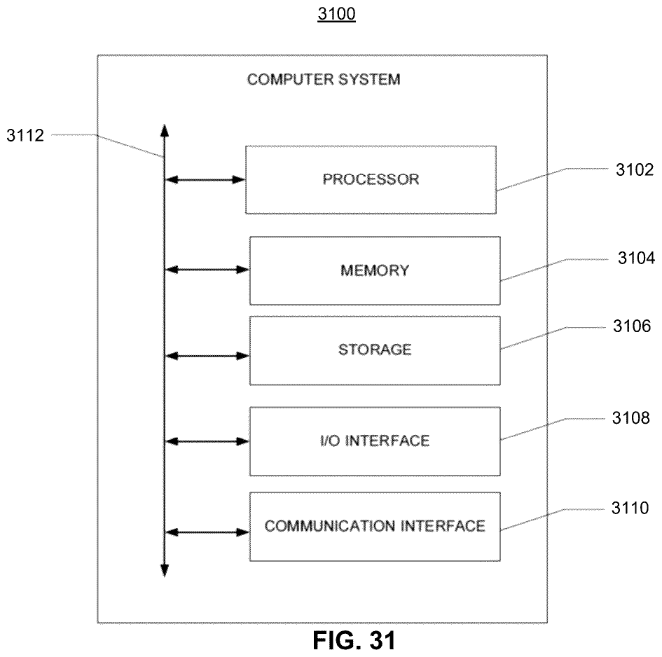

FIG. 31 illustrates an example computer system 3100. In examples, one or more computer systems 3100 perform one or more steps of one or more methods described or illustrated herein. In particular embodiments, one or more computer systems 3100 provide functionality described or illustrated herein. In examples, software running on one or more computer systems 3100 performs one or more steps of one or more methods described or illustrated herein or provides functionality described or illustrated herein. Examples include one or more portions of one or more computer systems 3100. Herein, reference to a computer system may encompass a computing device, and vice versa, where appropriate. Moreover, reference to a computer system may encompass one or more computer systems, where appropriate.

This disclosure contemplates any suitable number of computer systems 3100, such as server 2902, business client function 2904, or user accounts 2901 (e.g., user device). This disclosure contemplates computer system 3100 taking any suitable physical form. As example and not by way of limitation, computer system 3100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 3100 may include one or more computer systems 3100; be unitary or distributed; span multiple locations; span multiple machines; span multiple data centers; or reside in a cloud, which may include one or more cloud components in one or more networks. Where appropriate, one or more computer systems 3100 may perform without substantial spatial or temporal limitation one or more steps of one or more methods described or illustrated herein. As an example, and not by way of limitation, one or more computer systems 3100 may perform in real time or in batch mode one or more steps of one or more methods described or illustrated herein. One or more computer systems 3100 may perform at different times or at different locations one or more steps of one or more methods described or illustrated herein, where appropriate.

In examples, computer system 3100 includes a processor 3102, memory 3104, storage 3106, an input/output (I/O) interface 3108, a communication interface 3110, and a bus 3112 (e.g., communication bus). Although this disclosure describes and illustrates a particular computer system having a particular number of particular components in a particular arrangement, this disclosure contemplates any suitable computer system having any suitable number of any suitable components in any suitable arrangement.

In examples, processor 3102 includes hardware for executing instructions, such as those making up a computer program. As an example, and not by way of limitation, to execute instructions, processor 3102 may retrieve (or fetch) the instructions from an internal register, an internal cache, memory 3104, or storage 3106; decode and execute them; and then write one or more results to an internal register, an internal cache, memory 3104, or storage 3106. In particular embodiments, processor 3102 may include one or more internal caches for data, instructions, or addresses. This disclosure contemplates processor 3102 including any suitable number of any suitable internal caches, where appropriate. As an example, and not by way of limitation, processor 3102 may include one or more instruction caches, one or more data caches, and one or more translation lookaside buffers (TLBs). Instructions in the instruction caches may be copies of instructions in memory 3104 or storage 3106, and the instruction caches may speed up retrieval of those instructions by processor 3102. Data in the data caches may be copies of data in memory 3104 or storage 3106 for instructions executing at processor 3102 to operate on; the results of previous instructions executed at processor 3102 for access by subsequent instructions executing at processor 3102 or for writing to memory 3104 or storage 3106; or other suitable data. The data caches may speed up read or write operations by processor 3102. The TLBs may speed up virtual-address translation for processor 3102. In particular embodiments, processor 3102 may include one or more internal registers for data, instructions, or addresses. This disclosure contemplates processor 3102 including any suitable number of any suitable internal registers, where appropriate. Where appropriate, processor 3102 may include one or more arithmetic logic units (ALUs); be a multi-core processor; or include one or more processors 3102. Although this disclosure describes and illustrates a particular processor, this disclosure contemplates any suitable processor.

In examples, memory 3104 includes main memory for storing instructions for processor 3102 to execute or data for processor 3102 to operate on. As an example, and not by way of limitation, computer system 3100 may load instructions from storage 3106 or another source (such as, for example, another computer system 3100) to memory 3104. Processor 3102 may then load the instructions from memory 3104 to an internal register or internal cache. To execute the instructions, processor 3102 may retrieve the instructions from the internal register or internal cache and decode them. During or after execution of the instructions, processor 3102 may write one or more results (which may be intermediate or final results) to the internal register or internal cache. Processor 3102 may then write one or more of those results to memory 3104. In particular embodiments, processor 3102 executes only instructions in one or more internal registers or internal caches or in memory 3104 (as opposed to storage 3106 or elsewhere) and operates only on data in one or more internal registers or internal caches or in memory 3104 (as opposed to storage 3106 or elsewhere). One or more memory buses (which may each include an address bus and a data bus) may couple processor 3102 to memory 3104. Bus 3112 may include one or more memory buses, as described below. In examples, one or more memory management units (MMUs) reside between processor 3102 and memory 3104 and facilitate accesses to memory 3104 requested by processor 3102. In particular embodiments, memory 3104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 3104 may include one or more memories 3104, where appropriate. Although this disclosure describes and illustrates particular memory, this disclosure contemplates any suitable memory.

In examples, storage 3106 includes mass storage for data or instructions. As an example, and not by way of limitation, storage 3106 may include a hard disk drive (HDD), a floppy disk drive, flash memory, an optical disc, a magneto-optical disc, magnetic tape, or a Universal Serial Bus (USB) drive or a combination of two or more of these. Storage 3106 may include removable or non-removable (or fixed) media, where appropriate. Storage 3106 may be internal or external to computer system 3100, where appropriate. In examples, storage 3106 is non-volatile, solid-state memory. In particular embodiments, storage 3106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 3106 taking any suitable physical form. Storage 3106 may include one or more storage control units facilitating communication between processor 3102 and storage 3106, where appropriate. Where appropriate, storage 3106 may include one or more storages 3106. Although this disclosure describes and illustrates particular storage, this disclosure contemplates any suitable storage.

In examples, I/O interface 3108 includes hardware, software, or both, providing one or more interfaces for communication between computer system 3100 and one or more I/O devices. Computer system 3100 may include one or more of these I/O devices, where appropriate. One or more of these I/O devices may enable communication between a person and computer system 3100. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 3108 may include one or more device or software drivers enabling processor 3102 to drive one or more of these I/O devices. I/O interface 3108 may include one or more I/O interfaces 3108, where appropriate. Although this disclosure describes and illustrates a particular I/O interface, this disclosure contemplates any suitable I/O interface.

In examples, communication interface 3110 includes hardware, software, or both providing one or more interfaces for communication (such as, for example, packet-based communication) between computer system 3100 and one or more other computer systems 3100 or one or more networks. As an example, and not by way of limitation, communication interface 3110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 3110 for it. As an example, and not by way of limitation, computer system 3100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 3100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 3100 may include any suitable communication interface 3110 for any of these networks, where appropriate. Communication interface 3110 may include one or more communication interfaces 3110, where appropriate. Although this disclosure describes and illustrates a particular communication interface, this disclosure contemplates any suitable communication interface.

In particular embodiments, bus 3112 includes hardware, software, or both coupling components of computer system 3100 to each other. As an example and not by way of limitation, bus 3112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 3112 may include one or more buses 3112, where appropriate. Although this disclosure describes and illustrates a particular bus, this disclosure contemplates any suitable bus or interconnect.

This written description uses examples to enable any person skilled in the art to practice the claimed subject matter, including making and using any devices or systems and performing any incorporated methods. Other variations of the examples are contemplated herein. It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

The scope of this disclosure encompasses all changes, substitutions, variations, alterations, and modifications to the example embodiments described or illustrated herein that a person having ordinary skill in the art would comprehend. The scope of this disclosure is not limited to the examples described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. A method comprising:
receiving user interaction data associated with a platform for a predetermined period of time;
determining an online presence score associated with a user; and
ranking a plurality of advertisements (ads), wherein allocation of processing resources is based on the online presence score, associated with the user, in relation to a plurality of intervals, wherein:
the online presence score associated with a first interval of the plurality of intervals triggers more processing resources allocated to rank at least a portion of the plurality of ads; and
the online presence score associated with a second interval of the plurality of intervals triggers less processing resources allocated to rank at least another portion of the plurality of ads.

2. A system comprising:
a non-transitory memory with instructions stored thereon; and
a processor operably coupled to the non-transitory memory and configured to execute the instructions of:
receiving an augmented reality/mixed reality (AR/MR) image frame;
determining a first portion of the AR/MR image frame corresponds to static objects, and a second portion of the AR/MR image frame corresponds to dynamic objects;
adjust depth estimations of the second portion of the AR/MR image frame based on a previous motion-compensated depth map; and
output the adjusted depth estimations for the AR/MR image frame.

3. A method comprising:
receiving, at a server, an advertisement to be delivered to user accounts on a social media platform;
determining whether a user account should receive the advertisement at a pre-determined time interval or after a certain number of posts;
delivering the advertisement to the user accounts; and
resetting the timer feature.

4. The method of claim 3, wherein the social media platform sends the server an advertisement.

5. The method of claim 3, wherein the advertisement represents a feature of the business client or any third-party organization, brand, etc.

6. The method of claim 3, wherein the advertisement resembles any other article of content in a social media feed associated with a user profile.

7. The method of claim 3, wherein the developing a time rule personalized to the user and determining when best to insert the advertisement requires further analysis.

8. The method of claim 3, wherein the timer resets at the insertion of an advertisement in the content feed to count to the subsequent advertisement.

9. The method of claim 8, wherein the advertisement is inserted into the content feed seamlessly, mirroring the format of the surrounding pieces of content.

10. The method of claim 3, further comprising:
starting a timer function upon opening of a social media application associated with user profile;
measuring the length of time recorded by the device to display each article of content and determining the average length of time spent;
counting the articles of content displayed between scroll or click actions and over the course of the session on the social media platform; and
comparing the average length of time allocated per post to the average time allocated to a post generically; and
deciding which approach to insertion of the advertisement best suits the manner of engagement of the user with the social media platform.

11. The method of claim 10, wherein opening the application associated with the social media platform requires a user login and password.

12. The method of claim 10, wherein the application associated with the social media platform can be accessed via desktop computer, mobile device, tablet, etc.

13. The method of claim 10, wherein the timer starts counting as soon as the social media platform displays on the device.

14. The method of claim 10, wherein a server measures the length of time an article of content is displayed on the device and counts the articles of content between scroll or click actions within a session simultaneously.

15. The method of claim 10, wherein the advertisement insertion function compares the length of time a post is displayed with that of the generic social media platform experience to determine the manner by which the user interacts with the social media platform.

16. The method of claim 15, wherein the social media platform only opens once per session.

17. The method of claim 16, wherein the timer may start and restart several times during one session.

18. The method of claim 17, wherein based on the determination of the advertisement insertion function, the server will insert the advertisement after a pre-determined period of time or number of posts.
